(19) United States
(12) Patent Application Publication
(10) Pub. No.: US 2026/0008570 A1
(43) Pub. Date: Jan. 8, 2026

(54) POWER FEEDING DEVICE

(71) Applicant: Hiroshi MURAKAMI, Morioka Iwate (JP)

(72) Inventor: Hiroshi MURAKAMI, Morioka Iwate (JP)

(21) Appl. No.: 19/111,776

(22) PCT Filed: Dec. 25, 2024
(86) PCT No.: PCT/JP2024/045800

§ 371 Date: Mar. 13, 2025

(30) Foreign Application Priority Data
Jan. 14, 2024 (JP) 2024-003645
Feb. 25, 2024 (JP) 2024-026085
Mar. 29, 2024 (JP) 2024-056111
Jul. 2, 2024 (JP) 2024-106734
Jul. 14, 2024 (JP) 2024-113002
Sep. 23, 2024 (JP) 2024-164668
Nov. 9, 2024 (JP) 2024-196359

(51) Int. Cl. B64U 50/35; B64U 50/18; B64U 80/82; B64U 101/18

(52) U.S. Cl. CPC B64U 50/35; B64U 50/18; B64U 80/82; B64U 2101/18; B64U 2201/10

(57) ABSTRACT

[Subject] To provide a power feeder that harvests and supplies energy from the natural world.

[SOLUTION] The power feeder 81 comprises a first electrode 8112 formed by a conductor and placed in the earth or in water in a body of water in contact with the earth's crust at the tip where the conductor is exposed, a second electrode 8113 formed by a conductor and placed in the earth's atmosphere at the tip where the conductor is exposed, a The power collection unit 811, which converts the AC current input from the first electrode 8112 into DC current; the superposition unit 812, which boosts the DC power output by the power collection unit 811 by series connection; and the DC-AC conversion unit 813, which converts the DC power output by the superposition unit 812 into AC power.

### TECHNICAL FIELD

This invention relates to a power feeding device and an air defense system.

### BACKGROUND TECHNOLOGY

On the earth, wars have never ceased. And in many wars, explosives are sent through the air into enemy territory and detonated to destroy enemy equipment and buildings. And many civilians, uninvolved in the war, are killed.

In this regard, Nikola Tesla (Jul. 10, 1856-Jan. 7, 1943) once devised a method of destroying enemy flying objects by irradiating them with an electron beam using his invention, the so-called Tesla Coil. Apparently Nikola Tesla envisioned using only one Tesla coil to form the beam. (e.g., Non-Patent Document 1.)

However, it is difficult in practice to form a beam using only one Tesla coil.

One attack of defense concern is the so-called drone attack. This involves sending many small, self-destructing drones into the air, which approach near the target of destruction and self-destruct. In addition, there are concerns about attacks not only by flying objects but also by guerrilla-like soldiers from the ground.

In this regard, development of technology to irradiate drones with high-power microwaves and destroy their airframes and control circuits is underway (see, for example, Non-Patent Document 2).

However, this technology cannot cope with extremely large numbers of drones or guerrilla attacks from the ground.

In the outdoors, where there are no power transmission facilities, or in areas where power supply by power transmission facilities is no longer possible due to disasters, etc., power supply equipment independent of conventional power transmission facilities is required. For such power feeders, there are internal combustion power feeders that obtain power by burning gasoline or LP gas, and power feeders that use natural energy such as sunlight.

However, in the case of internal combustion-motor power feeders, fuel must be continuously secured, and power feeders that use natural energy are susceptible to weather and other natural conditions.

In this regard, a device has been proposed in which two accumulators can permanently supply power to the outside world by alternately charging each other (e.g., Non-Patent Document 3, page 309, “Dr. Dollard's Free Energy Vehicle”).

However, this technology is suspected to be a so-called perpetual motion idea and has not been widely put into practice.

Aircraft differ in function, equipment, and shape depending on their intended use. In recent years, the V-22 (commonly known as the Osprey. For example, see Non-Patent Document 4.) In recent years, the V-22 (commonly known as the Osprey) and other vertical takeoff and landing aircraft have been published for transportation and are mainly used for military purposes. In addition, the F-35B (see, for example, Non-Patent Document 5) and other aircraft that can be used as fighter planes have been published and are mainly used for military purposes.

However, the V-22 tends to be unstable when changing propeller direction, and the F-35B cannot take off vertically.

Furthermore, all of these components, such as the main wings, are large and require a large space for storage.

[Non-Patent Document 1] “The Tesla Files—Mysterious, top—secret research” (https://www.amazon.co.jp/% E3%82%B3%E3%83%AD%E3%83%A9%E3%83%89% E5%AE%9F%E9%A8%93/dp/B09RK36KZT/ref=sr_1_1?_mk_ja_JP=% E3%82%A B%E3%82%BF%E3%82%AB%E3%83%8A&keywords=%E3%83%86%E3%82%B9% E3%83%A9%E3%83%95%E3%82%A1%E3%82%A4%E3%83%AB&qid=1705181 624&s=instant-video&sr=1-1)

[Non-Patent Document 2] “Defense Ministry to Develop ‘High-Power Microwave’ Weapon . . . to Disable Military Drones.” (https://www.yomiuri.co.jp/national/20220205-OYT1T50129/)

[Non-Patent Document 3] “Nikola Tesla's [Complete Technological] Commentary,” by Nikola Tesla, translated by Kazumoto Iguchi, Sep. 30, 2015, Hikarland Corporation

[Non-Patent Document 4] “MV-22 Osprey,” https://www.mod.go.jp/j/approach/anpo/osprey/haibi/pdf/mv22_pamphlet.pdf

[Non-Patent Document 5] “FY 2020 Defense White Paper<Commentary>Acquisition of F-35B Fighter Aircraft” https://www.mod.go.jp/j/publication/wp/wp2020/html/nc 007000.html

### SUMMARY OF THE INVENTION

### Problem to be Solved

The problem to be solved by the present invention is to provide an air defense system that can effectively destroy flying objects.

The problem to be solved is to provide a shield barrier generator that can effectively defend against attacks.

The problem that the present invention seeks to solve is to provide a power feeder that harvests and supplies energy from the natural world. Also, the problem to be solved is to provide a wireless power transmission system that transmits power by radio.

The problem to be solved by this invention is to provide a space-saving aerial mobile unit.

The above “Background Art” and “Problem to be Solved” indicate the occasion (trigger) that led to the invention, and do not limit the technical scope of the invention, nor do they allow for a limited interpretation of the technical scope of the invention (see Japanese Patent Office Examination Guideline No. 2005 (Gyo-Ke) 10042, and Japanese Patent Office Examination Guideline Part II, Chapter II, Unit 2, 3.2.1 as of the filing date of the application).

### Means to Solve the Problem

According to the present invention, a power feeder 81 comprises a power collection unit 811 comprises a first electrode 8112 formed by a conductor and placed in water in the earth or in a body of water in contact with the earth's crust at the tip where the conductor is exposed, a second electrode 8113 formed by a conductor and placed in the earth's atmosphere at the tip where the conductor is exposed, an AC-DC converter 811 that converts the AC current input from the first electrode 8112 into DC current, a DC-AC converter 813 that converts the DC power output by the power collection unit 811 into AC power can be provided.

According to the present invention, an air defense system that can effectively destroy flying objects can be provided.

According to the present invention, it is possible to provide a shield barrier generator that can effectively defend against attacks.

According to the present invention, there can be provided a power feeder that harvests and supplies energy from the natural world.

According to the present invention, a space-saving aerial vehicle can be provided.

### BRIEF DESCRIPTION OF DRAWINGS

FIG. 1 block diagram of the phased array tesla coil air defense system of the first embodiment.

FIG. 2 A circuit diagram showing a Tesla coil.

FIG. 3 An exploded side view of the Tesla coil.

FIG. 4 A side view of the 41 Tesla coils.

FIG. 5 A flowchart showing the operation of the main control unit.

FIG. 6 A block diagram showing the configuration of the phased array tesla coil air defense system for the second embodiment.

FIG. 7 A block diagram showing the configuration of the shield barrier generator for the first embodiment.

FIG. 8 A block diagram showing the configuration of the first type of power feeder.

FIG. 9 An external view of the oscilloscope used for the measurement.

FIG. 10 An external view of the oscilloscope during measurement.

FIG. 11 An enlarged view of the display of the oscilloscope shown in

FIG. 12 A side view of the aerial mobile unit.

FIG. 13 An A-arrow view of the aerial mobile unit in FIG. 12.

FIG. 14 Arrow B view of the aerial mobile in FIG. 12.

FIG. 15 A plan view of the aerial mobile with components removed.

FIG. 16 C-sagittal end view of the receiving part in FIG. 15.

FIG. 17 A diagram of the combat component.

FIG. 18 An example of a jet engine.

FIG. 19 An example of a jet engine with the flap for reverse thrust opened.

FIG. 20 A block diagram of the motion controller.

FIG. 21 The figure below shows an example of the data structure of an attitude table.

FIG. 22 The figure below shows an example of the data structure of a motion condition table.

FIG. 23 The figure below shows an example of the data structure of a component control table.

FIG. 24 This block diagram shows the structure of the first type of power transmission system.

FIG. 25 The figure shows the changes in the transmission radio waves of the power transmission system.

FIG. 26 The block diagram shows a variation of the power transmission system for the first embodiment.

FIG. 27 The block diagram shows the configuration of a power transmission device that can be used in the first embodiment of the power transmission system.

FIG. 28 This block diagram shows the configuration of a direction conversion unit.

### EMBODIMENTS TO IMPLEMENT THE INVENTION

### Phased Array Tesla Coil Air Defense System

The following is a detailed description of a phased array Tesla coil air defense system (hereinafter referred to as “air defense system 1”) according to one embodiment of the present invention.

### First Embodiment

### System Configuration

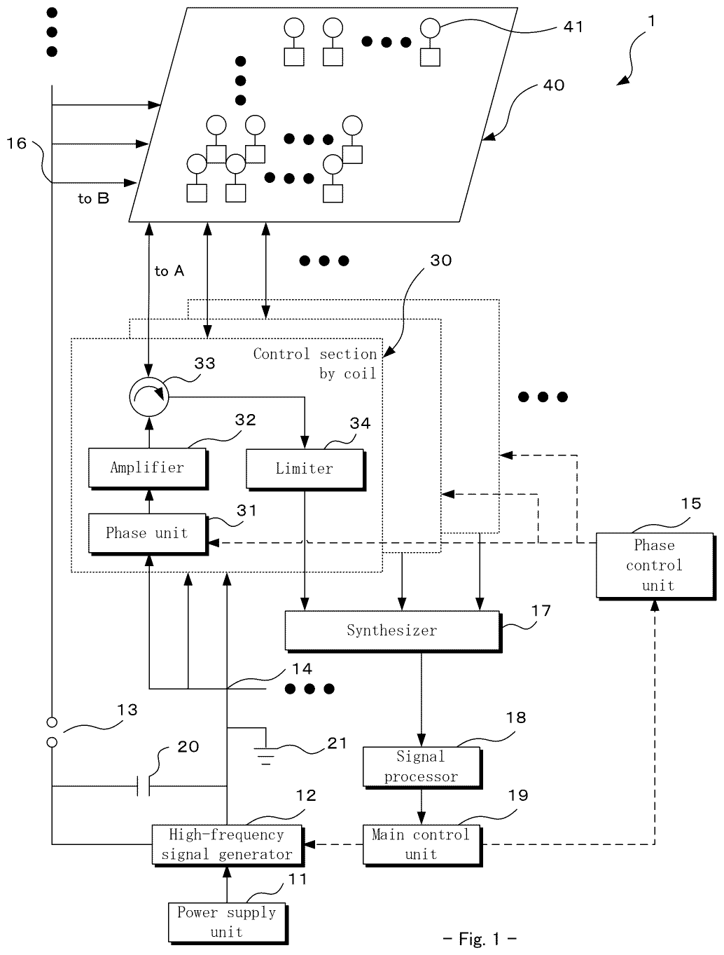

FIG. 1 is a block diagram showing the configuration of the air defense system 1 for the first embodiment of the invention. As shown in FIG. 1, the air defense system 1 comprises a power supply unit 11, a high-frequency signal generator 12, a gap switch 13, a capacitor 20, a coil-specific control unit 30, an array of array Tesla coils 40 arranged in an array (two-dimensional shape), a main control unit 19, a phase control unit 15, a synthesizer 17, a signal processing device 18.

The power supply unit 11 supplies AC power to the loads housed inside. The power supply unit 11 may receive power from the power feeder 81 described below, or a separate secondary battery may be installed to store the received power.

The RF signal generator 12 generates RF signals in the MHz to GHz range using the power input from the power supply unit 11. The generation method can be, for example, the known method used in conventional phased array radar. For details of this technique, see, for example, “Introduction to Radar Systems,” Merrill I. Skolnick (original), Kenki Ogura (translation), Pleiades Publishing, Jul. 25, 2023. (Hereafter referred to as Reference 1.) and others.

The output signal from the high-frequency signal generator 12 is split into two, one output to the gap switch 13 and the other to the respective phasor 31 of the coil-specific control unit 30 via the first branch point 14.

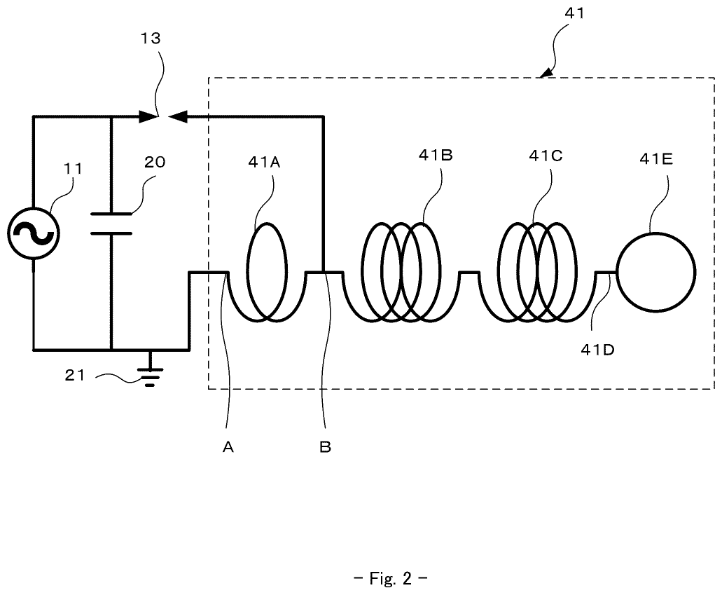

The gap switch 13 comprises two conductor ends, e.g. spheres formed by conductor metals, spaced apart in the atmosphere, with the output side connected via a second branch point 16 to a second connection point B (see FIG. 2) of each of the Tesla coils 41 of the array Tesla coils 40.

A capacitor 20 is provided on the input side of the gap switch 13 and on the output side of the high-frequency signal generator 12, with connection terminals connecting to the input side of the gap switch 13 and to the output side of the high-frequency signal generator 12, respectively.

The coil-specific control unit 30 comprises a phasor 31, an amplifier 32, a circulator 33, and a limiter 34.

The phaser 31 shifts the phase of the input high-frequency signal by the phase shift amount set by the phase controller 15 and outputs it.

Amplifier 32 amplifies the high-frequency signal input from phaser 31.

Circulator 33 outputs the input signal from the next output terminal in a clockwise direction. Thus, the output signal from amplifier 32 is the first connection point A of each of the array tesla coils 40, 41 (see FIG. 2.).

Circulator 33 also outputs the received signal input from the first connection point A of each of the array tesla coils 41 of the array tesla coils 40 to the limiters 34.

The limiter 34 filters out excessive power and frequencies that would be harmful to subsequent equipment. The output signal from the limiter 34 is input to the synthesizer 17.

Synthesizer 17 combines the frequency signals from the limiters 34 of the respective coil-specific control unit 30 and outputs them to signal processor 18.

Signal processor 18 demodulates the modulation applied to the combined received signal, converts it into a signal that can be processed by the main control unit 19, and outputs it to the main control unit 19.

The main control unit 19 can be a so-called computer equipped with an arithmetic unit, a memory unit, and input/output devices. The main control unit 19 outputs control signals to the high-frequency signal generator 12 and to the phase control unit 15 and uses the input signals from the signal processor 18 to output images to the input/output devices, as well as to prepare the next attack position.

The formation method, operation, and control method, etc., of each of the above components can be used as well as the known methods, etc., described in detail in Reference 1 above.

### Tesla Coil

### 1. Configuration of Tesla Coil

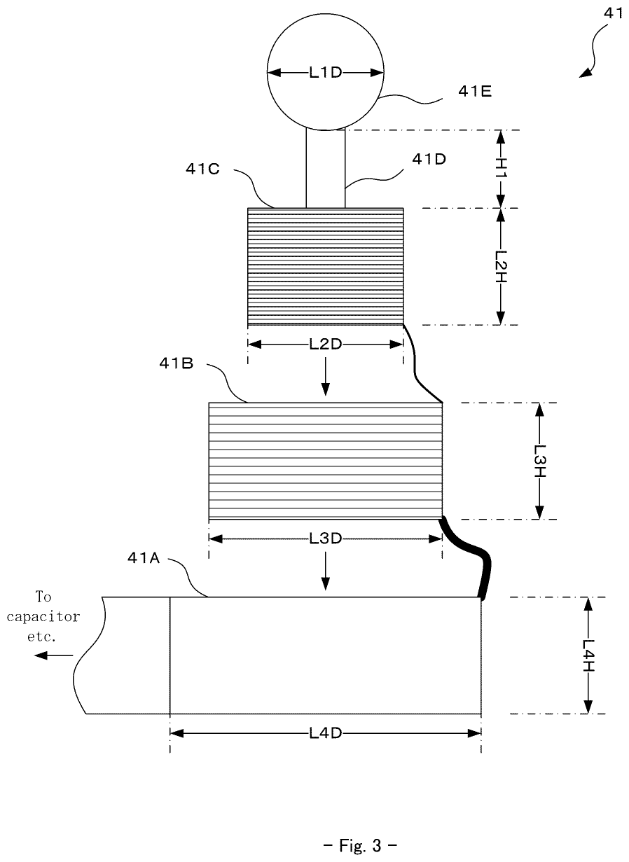

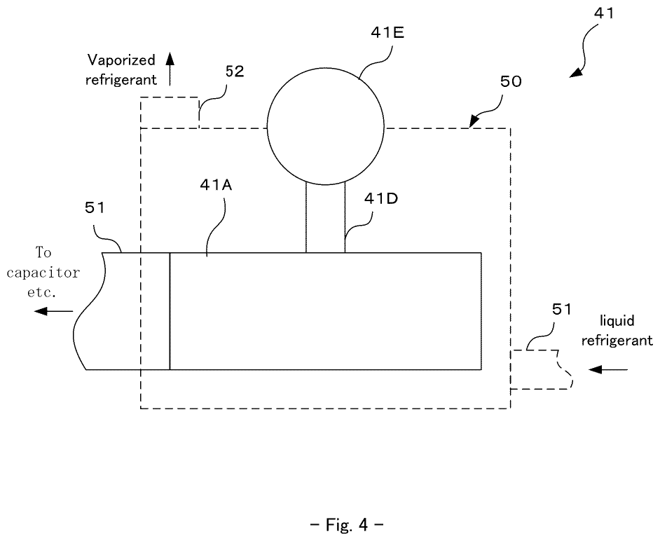

FIG. 2 shows a circuit diagram of the Tesla coil 41. FIG. 3 is an exploded side view of the Tesla coil 41. FIG. 4 is a side view of the Tesla coil 41.

As shown in FIGS. 2 to 4, the Tesla coil 41 comprises a first coil 41A with one end connected to a first connection point A and the other end connected to the gap switch 13 and the secondary coil 41B via a second connection point B, a secondary coil 41B with one end connected to the gap switch 13 and the secondary coil 41B and the other end connected to a third coil 41C, the thied coil 41C with one end connected to the other end of the secondary coil 41B and the other end connected to a spherical antenna 41E via a lead delay 41D, the spherical antenna 41E that connects to the other end of the lead delay 41D.

The energized parts of the Tesla coil 41, namely the first coil 41A, the secondary coil 41B, the third coil 41C, the lead delay 41D, the spherical antenna 41E, and the connecting wires that connect them, can be made of a single conductive metal such as copper or gold or an alloy. Each wire used for the first coil 41A, the secondary coil 41B, the third coil 41C, and the lead delay 41D is insulated and coated.

The first coil 41A, the secondary coil 41B, the third coil 41C, the lead delay 41D, the sphere antenna 41E, and the connecting wires that connect them can be formed using superconducting materials in addition to the conductor materials normally used. The superconducting material can be, for example, a rare-earth high-temperature superconducting wire.

For example, HgBaCaCuO, TIBaCaCuO, BiSrCaCuO, and YBaCuO can be used as rare-earth high-temperature superconductors. Rare earth-based high-temperature superconducting materials exhibit a superconducting state even when cooled by liquid nitrogen. Conventional superconducting materials such as MgB2 and Nb3Sn can also be used. Conventional superconducting materials exhibit a superconducting state when cooled by liquid helium. These wires can be made from known materials that are already commercially available from Fujikura Ltd.

As shown in FIG. 3 and FIG. 4, the height L4H of the first coil 41A, the height L3H of the secondary coil 41B, and the height L2H of the third coil 41C should be approximately the same length as the diameter of the sphere antenna 41E for efficiency, but they can be different from each other.

The first coil 41A, the secondary coil 41B, and the third coil 41C have a cylindrical shape. the diameter L4D of the first coil 41A is larger than the diameter L3D of the secondary coil 41B and smaller than the size where electromagnetic induction does not occur with each other. the diameter L3D of the secondary coil 41B is larger than the diameter L2D of the third coil 41C and smaller than the size where electromagnetic induction does not occur with each other. The diameter L2D of the third coil 41C is larger than the diameter of the horizontal cut plane of the lead delay 41D.

The height of the lead delay 41D is only H1 higher than the height L4H of the first coil 41A, the height L3H of the secondary coil 41B, and height L2H of the third coil 41C. Therefore, all of the spherical antenna 41E is exposed outside of the first coil 41A, the secondary coil 41B, and the third coil 41C.

The number of turns of the third coil 41C is larger than the number of turns of the secondary coil 41B. For example, the number of turns of the third coil 41C can be 10 to 100 times more than the number of turns of the secondary coil 41B.

The number of turns of the secondary coil 41B is larger than the number of turns of the first coil 41A. For example, the number of turns of the secondary coil 41B can be 10 to 100 times more than the number of turns of the first coil 41A.

The number of turns of the first coil 41A may be one, for example.

When the first coil 41A, the secondary coil 41B, the third coil 41C, the lead delay 41D, the spherical antenna 41E, and the connecting wires that connect them are formed using superconducting materials, as shown in FIG. 4, a cooling machine 50 is installed to house all these components.

The cooling machine 50 internally houses the first coil 41A, the secondary coil 41B, the third coil 41C, the lead delay 41D, and all of the connecting wires connecting them, as shown in FIG. 4, and at least the top half of the spherical antenna 41E. The cooling machine 50 comprises an inlet hole 51 that allows liquid coolant to flow into the interior and a pneumatic valve 52 that releases the vaporized liquid coolant.

The liquid coolant can be a liquid that can cool the superconducting material to a low temperature until it reaches a superconducting state, such as liquid helium or liquid nitrogen.

### 2. Tesla Coil Operation

Tesla coil 41 boosts the high-frequency signal input to the first coil 41A by electromagnetic induction, using the secondary coil 41B and the third coil 41C to make the frequency higher.

By the way, the gap switch 13 and capacitor 20 are connected to the Tesla coil 41, which operates as follows.

The core of the earth's crust contains iron (Fe). In other words, the earth is a sphere of iron, a conductor. And while the earth rotates on its own axis and orbits the sun, the sun has a magnetic field, and this magnetic field often changes, such as in magnetic storms.

As the earth, an iron sphere, moves through this magnetic field, induced currents are generated inside the earth. The earth is then covered by an atmosphere that is an insulator and has electrostatic capacitance.

In other words, the earth is like a large capacitor, with currents in the crust and the atmosphere storing capacitance.

Nikola Tesla discovered this current in the crust and called it a standing wave.

Here, when the input power to capacitor 20 reaches its capacity, capacitor 20 discharges in the direction of gap switch 13.

The gap switch 13 becomes energized when the atmosphere between the two conductor ends is ionized by this discharge.

Here, some of the capacitance that the atmosphere had flows into the Tesla coil 41 through gap switch 13.

Thus, Tesla coil 41 can discharge a spark much larger than the power supplied by power supply unit 11, because it also has power input from gap switch 13.

### Beam Output

This form of air defense system 1 irradiates beam sparks in the desired direction by a method similar to the method used to generate beam transmission signals for phased-array radar.

Detailed examples of beamforming methods are described, for example, in Reference 1, and these known methods can be used.

### Beam Irradiation Target Supplementation

The air defense system 1 identifies the location of the beam irradiation target by a method similar to the target supplementation method of phased-array radar.

Detailed examples of phased array radar target supplementation methods are described, for example, in Reference 1, and these known methods can be used.

### Method of Destroying Equipment to be Destroyed

Flying objects, such as those carrying explosives, are usually equipped with an explosive device that destroys the flying object itself to prevent accidental detonation in the home country.

Then, if the flying object misses the desired launch, for example, a signal is sent to the flying object to blow it up.

Here, an antenna is needed to receive this signal. And this antenna has a length that is an integer multiple of λ/4 relative to the frequency λ of the high-frequency signal used in the internal circuitry. This antenna accepts high-frequency signals of frequency A and reflects other frequencies.

Thus, if the spark is irradiated by this frequency λ, a powerful power will be input from the antenna, effectively destroying the flying object.

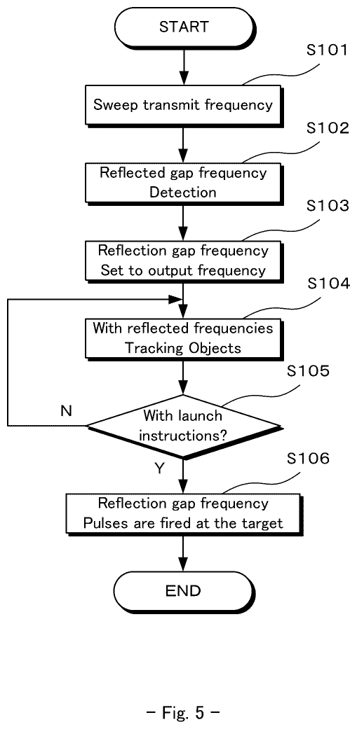

FIG. 5 is a flowchart showing the operation of the main control unit 19 of the air defense system 1. As shown in FIG. 5, in step S101, the main control unit 19 instructs the RF signal generator 12 to sweep the frequency. The sweep range is within the frequency band used for normal communication.

In step S102, the main control unit 19 monitors the received signal intensity at each sweep frequency and detects the reflected gap frequency where the received signal intensity is lower than the other frequencies.

In step S103, the main control 19 sets the reflection gap frequency to the output frequency of the spark.

In step S104, the main control 19 tracks the object to be destroyed by the reflection frequency, which is a frequency other than the reflection gap frequency.

In step S105, the main control unit 19 determines whether a launch instruction has been received. If the main control 19 determines that a launch instruction has been received (Y in step S105), it proceeds to step S106, and if it does not determine that a launch instruction has been received (N in step S105), it returns to step S105.

In step S105, the main control unit 19 causes the phase controller 15 to calculate the phase to generate the beam in the direction of the spark irradiation and transmits the phase change to the phase unit 31 of the respective coil-specific control unit 30. The main control unit 19 then instructs the RF signal generator 12 to output a high power reflection gap frequency RF.

The generated high power reflected gap frequency radio frequency signal is input to each of the 41 Tesla coils with the phase adjusted via the coil-specific control unit 30, and the gap switch 13 is turned on (energizable) by the discharge of capacitor 20, and power stored in the atmosphere flows in through gap switch 13.

The Tesla coil 41 then beams the phase-adjusted spark at the object, and the object is destroyed.

As described above, the air defense system 1 in this embodiment comprises a power supply unit 11 that supplies AC power, a high-frequency signal generator 12 that generates high-frequency signals using the power supplied by the power supply unit 11, a gap switch 13 connected to one of a pair of output terminals from the high-frequency signal generator 12 with two conductor ends spaced apart in the atmosphere, a capacitor 20 connected to both of a pair of output terminals from the high-frequency signal generator 12, a coil-specific control unit 30 with a phasor 31 that changes the phase of the high-frequency waves generated by the high-frequency signal generator 12 by a specified amount, array Tesla coil 40 that the number of coil turns increases in the order of the first coil 41A, the secondary coil 41B, and the third coil 41C. The output from the high-frequency signal generator 12 is input to the first connection point A, which is one end of the primary coil 41A, the output from the gap switch 13 is input to the second Array Tesla coil 40 in which a plurality of Tesla coils 41 are arranged in an array, which is a two-dimensional arrangement of a plurality of coils, and a spherical antenna 41E is connected to the output end of the third coil 41C via a bar-shaped lead delay 41D,

Thus, the present invention has an effect of providing an air defense system that can efficiently destroy flying objects.

### Second Embodiment

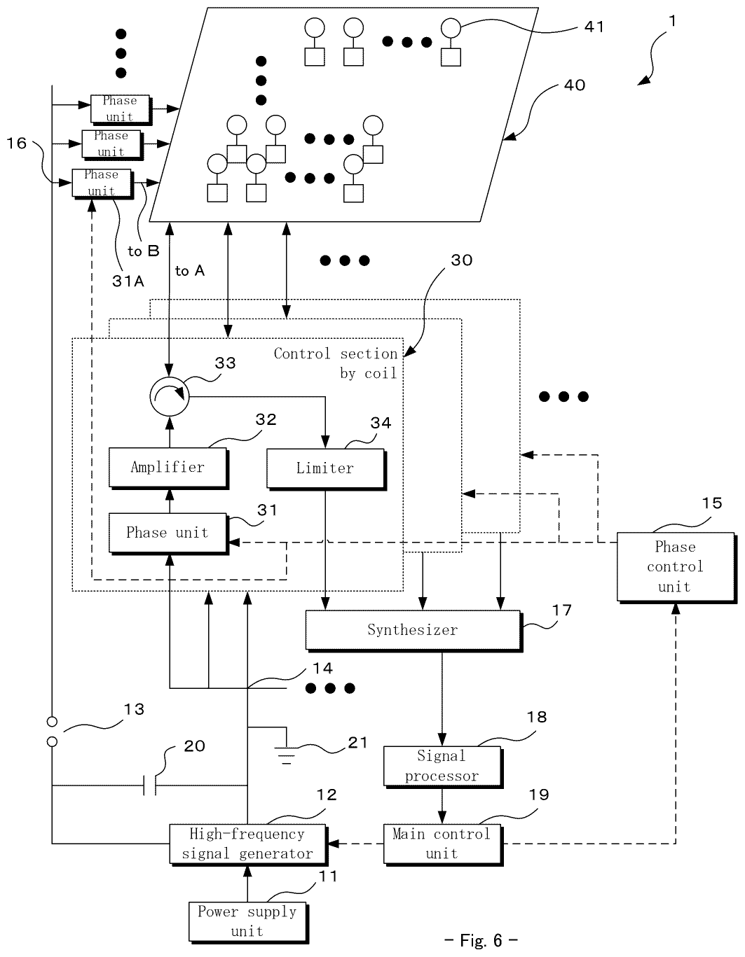

FIG. 6 is a block diagram showing the configuration of the air defense system 1 for the second embodiment. Only the differences from the first embodiment will be explained below.

In this embodiment, at the rear of the second branch point 16 between the output side of the gap switch 13 and the input terminal to the second connection point B of each Tesla coil 41, the air defense system 1 further comprises a phase unit 31A that inputs the amount of phase indicated by the phase unit 31 and changes the phase of the high-frequency signal input from the gap switch 13.

Thus, according to the air defense system 1 of the second embodiment of the invention, the input signal from the gap switch 13 can also be phase aligned, which has the effect of destroying the object more efficiently.

### Shield Barrier Generator

The following is a shield barrier generator (hereinafter referred to as “Barrier Generator 71”) that can effectively defend against attacks in accordance with one embodiment of the present invention. The following is a detailed description of a shield barrier generator (hereinafter referred to as “barrier generator 71”) that can effectively defend against attacks in accordance with one embodiment of the invention.

### First Embodiment

### Basic Idea

When electromagnetic waves of frequencies f₁ and f₂ are synthesized and irradiated in the same direction, the electromagnetic waves are superimposed and their amplitude increases with each wavelength λ that advances, corresponding to the frequency f_{L}, the least common multiple of these frequencies.

In this form of barrier generator 71, n frequencies fₚ obtained by multiplying the fundamental frequency f₀ chosen from prime numbers by the product P_{C} of combinations of prime numbers are generated from frequency fₚ₁ to frequency fₚₙ, these phases are aligned and synthesized, and this synthetic wave is irradiated.

Then the electromagnetic wave is superimposed and its amplitude increases with each wavelength Δ_{P} that advances, corresponding to the least common multiple frequencies f_{PL} of the n frequencies from fₚ₁ to fₚₙ.

If λ_{P} is set at some distance from the irradiator, the energy is relatively small just before Δ_{P} from the irradiator, but at λ_{P} the energy is n times f_{P}.

Thus, a shield barrier, a curtain of high-energy electromagnetic waves that block enemy attacks or intrusion, can be generated at λ_{P}.

### Configuration Example

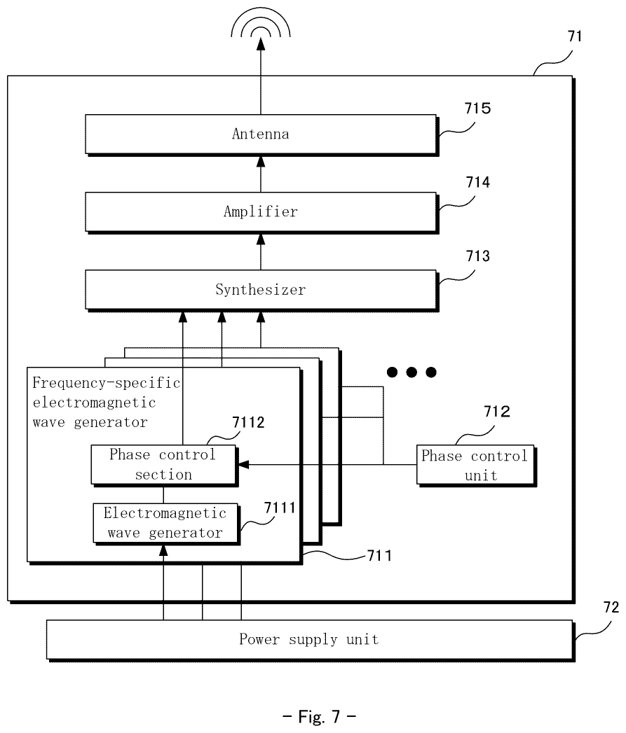

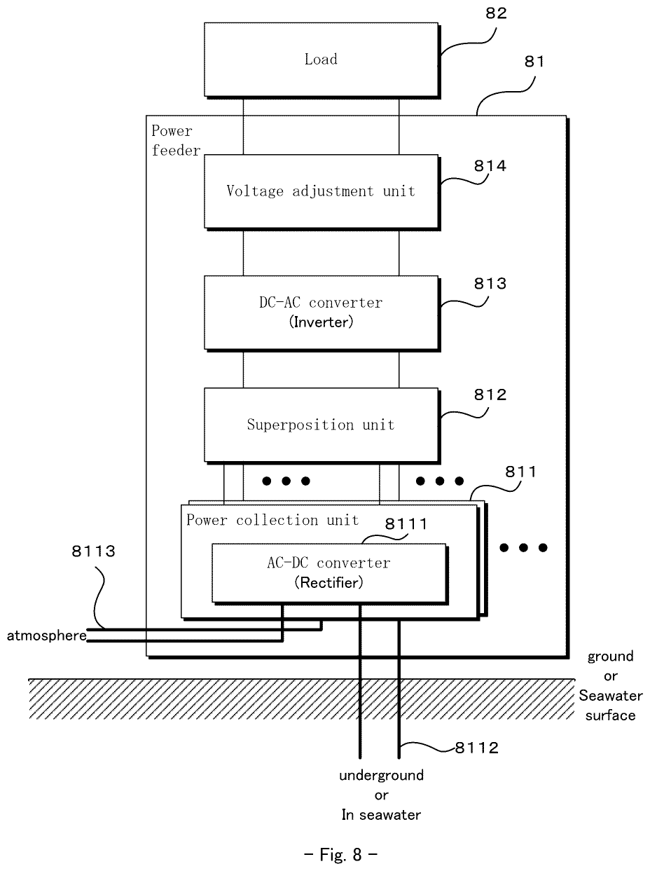

FIG. 7 is a block diagram showing the configuration of the barrier generator 71. As shown in FIG. 7, the barrier generator 71 comprises a frequency-specific electromagnetic wave generator 711, a phase control unit 712, a synthesizer 713, an amplifier 714, and an antenna 715. The barrier generator 71 may also be equipped with a power supply unit that supplies power received from the power feeder 81 (described below) to loads housed inside, or a separate secondary battery may be provided to store the received power.

The frequency-specific electromagnetic wave generator 711 comprises an electromagnetic wave generator 7111 and a phase unit 7112. The frequency-specific electromagnetic wave generator 711 comprises n (n is an integer.) of frequency-specific electromagnetic wave generators 711-1 to frequency-specific electromagnetic wave generators 711-n for each frequency to be generated.

The first electromagnetic wave generator 7111-1, one of the electromagnetic wave generators 7111, generates electromagnetic waves of frequency f_{P1}, one of the frequencies f_{P}, using power supplied from the power supply unit 72.

The frequency f_{P1} is the frequency obtained by multiplying the fundamental frequency f₀ chosen from prime numbers by the combination of prime numbers P_{C}.

The fundamental frequency f₀ chosen from prime numbers is chosen from prime numbers greater than 3000, for example, and specifically 3011 can be chosen.

The product P_{C} of a combination of prime numbers is, for example, a combination of prime numbers chosen from relatively small prime numbers, specifically, the product of a combination of prime numbers such as 1, 5, 7, 11, etc. can be selected.

If the prime numbers above are selected, the product P_{C} of the prime number combination is chosen from one of the following, for example

$$1$$

$$1 \times 5 = 5$$

$$1 \times 7 = 7$$

$$:$$

$$1 \times 5 \times 7 = 35$$

$$:$$

$$1 \times 5 \times 7 \times 11 = 385$$

The number C_{S} of the product P_{C} of this combination of prime numbers is 15, as shown in (1) below.

[numerical formula 1]

[symbol]

Thus, n=C_{S}=15 in the above case.

And if the fundamental frequency f₀ is 3011, and the frequency fₚ obtained by multiplying the product P_{C} of the above combination of prime numbers is 15, from fₚ₁ to fₚ₁₅, then the frequency f_{PL} of the least common multiple of the 15 frequencies from fₚ₁ to fₚ₁₅ is 1,159,235.

In this case, the wavelength λ_{P} corresponding to the least common multiple frequency f_{PL} is λ_{P}=258.791362 m by solving the following equation (2) for λ_{P}.

[numerical formula 2]

[symbol]

However, C is the speed of light in vacuum, and in the above calculation the speed of electromagnetic waves in air is approximated by the light speed C=3×10⁸ m.

Thus, for the above conditions, a shield barrier is generated with relatively low energy just before λ_{P}=258.791362 m from the irradiation device, but at λ_{P} the energy is 15 times fₚ.

The phase control unit 712 aligns the phase or varies the position of the aligned phase. The phase control unit 712 can adjust the thickness of the barrier relative to the direction of travel at the position of λ_{P} by periodically varying the position of the aligned phase.

The phaser 7112 aligns the phases of the electromagnetic wave generator 7111 according to the control signal of the phase control unit 712.

The synthesizer 713 synthesizes the electromagnetic waves input from the n frequency-specific electromagnetic wave generators 711-1 through 711-n frequency-specific electromagnetic wave generators.

Amplifier 714 amplifies the electromagnetic waves output from synthesizer 713.

Antenna 715 radiates electromagnetic waves amplified by amplifier 714 into the air.

As described above, the barrier generator 71 in this embodiment generates n (n is an integer.) of frequencies fₚ from frequency fₚ₁ to frequency fₚₙ out of the frequency fₚ obtained by multiplying the fundamental frequency f₀ chosen from prime numbers by the product P_{C} of combinations of prime numbers. The electromagnetic wave generator 711 generates electromagnetic waves of each frequency fₚ, the synthesizer 713 synthesizes the n electromagnetic waves input from the electromagnetic wave generator 711 by frequency, the amplifier 714 amplifies the electromagnetic waves output from the synthesizer 713, and an antenna 715 radiates the electromagnetic waves amplified by the amplifier 714 into the air.

Thus, the present invention has the effect of providing a shield barrier generator that can effectively defend against attacks.

### Second Embodiment

### Basic Idea

In the barrier generator 71 of this embodiment, circularly polarized electromagnetic waves fₚ with angular velocity ωₚ obtained by multiplying the basic angular velocity ω₀ of angular velocity selected from prime numbers by the product P_{C} of the combination of prime numbers are generated from circularly polarized electromagnetic waves fₚ₁ with angular velocity ωₚ₁ to circularly polarized waves fₚₙ with angular velocity ωₚₙ The phase of these waves is aligned and synthesized, and this synthesized wave is irradiated.

Then the electromagnetic wave is superimposed and its amplitude increases with each advance of angle θ_{P} corresponding to ω_{PL}, the least common multiple of the n frequencies from ωₚ₁ to ωₚₙ.

If the angle θ_{P} is set to occur at some distance Z from the irradiator, the energy is relatively small just before Z from the irradiator, but at Z the energy is n times fₚ.

Thus, a shield barrier, a curtain of high-energy electromagnetic radiation that blocks enemy attack or intrusion, can be generated at the Z location.

### Configuration Example

This configuration example differs from the configuration example of the first embodiment only in the electromagnetic wave generator unit 711. Therefore, only the electromagnetic wave generator 711 will be described below, and explanations of the other configurations will be omitted.

The basic angular velocity ω₀ of the angular velocity chosen from the prime numbers is, for example, 3 radians. The combination of prime numbers is the prime numbers listed in the first form.

The product P_{C} of combinations of prime numbers is the same as the product P_{C} of combinations of prime numbers in the first example. Therefore, the maximum amplitude of the composite wave of n circularly polarized electromagnetic waves fₚ of circularly polarized electromagnetic waves fₚ₁ with angular velocity ωₚ₁ to fₚₙ with angular velocity ωₚₙ is θ=3×385=1,155 (radians).

Thus, Z can be obtained by substituting θ=3×385=1,155 (radians) into the following equation (3) and solving for Z.

[numerical formula 3]

[symbol]

However, β₀ is the phase constant and t is the time, which can be set arbitrarily.

In the case of the above conditions, a shield barrier is generated with relatively low energy just before distance Z from the irradiation device, but at distance Z the energy is 15 times fₚ.

As described above, the barrier generator 71 of this form of barrier generation comprises electromagnetic wave generators 711 generate n (n is an integer.) circularly polarized electromagnetic waves fₚ₁ with angular velocity ωₚ₁ to fₚₙ with angular velocity ωₚₙ for each circularly polarized electromagnetic wave fₚ with angular velocity ωₚ obtained by multiplying the basic angular velocity ω₀ chosen from the prime numbers by the product P_{C} of the combination of prime numbers, a synthesizer 713 synthesizes the n electromagnetic waves input from the electromagnetic wave generators 711 by frequency, an amplifier 714 amplifies the electromagnetic waves output from the synthesizer 713, and an antenna 715 radiates the electromagnetic waves amplified by the amplifier 714 into the air.

Thus, the present invention has the effect of providing a shield barrier generator that can effectively defend against attacks.

### Third Embodiment

### Basic Idea

Each frequency in the first embodiment and the second embodiment are improved and applied. In other words, the n (n is an integer.) of frequencies fₚ₁ to fₚₙ of the first embodiment are generated for each frequency fₚ. The electromagnetic wave generator 711 generates electromagnetic waves of each frequency fₚ, and the circularly polarized electromagnetic wave generator 711 generates circularly polarized electromagnetic waves of angular velocity ωₚ from the circularly polarized electromagnetic wave fₚ₁ of angular velocity ωₚ₁ of the circularly polarized electromagnetic wave fₚ with angular velocity ωₚ obtained by multiplying the basic angular velocity ω₀ of the angular velocity selected from the prime numbers in the second embodiment by the product P_{C} of the combination of the prime numbers. n electromagnetic waves fₚₙ (n is an integer.) The ω_{PL} and t are selected so that λP=Z.

Then, at a distance λ_{P}=Z, a shield barrier is generated whose energy is 15×15=225 times that of fₚ.

As described above, the barrier generator 71 of this form of barrier generation comprises electromagnetic wave generators 711 generate n (n is an integer.) circularly polarized electromagnetic waves fp1 with angular velocity ωp1 to fpn with angular velocity ωpn for each circularly polarized electromagnetic wave fp with angular velocity ωp obtained by multiplying the basic angular velocity ω0 chosen from the prime numbers by the product PC of the combination of prime numbers, a synthesizer 713 that synthesizes n electromagnetic waves input from frequency-specific electromagnetic wave generators 711, amplifier 714 that amplifies the electromagnetic waves output from synthesizer 713, and antenna 715 that radiates the electromagnetic waves amplified by amplifier 714 into the air.

Thus, the present invention has the effect of providing a shield barrier generator that can more effectively defend against attacks.

### Power Feeding Device

The following is a detailed description of a power feeder 81 in accordance with one embodiment of the invention, with reference to the drawings.

### Intra-Terrestrial Electric Power

Nikola Tesla (1856-1943) had found that electric power exists in the interior of the earth in the form of waves. However, Nikola Tesla recalled that it seems that he was trying to obtain electric power from these standing waves, but that it seems difficult to harness this electrical energy. In addition, the conventional electric power inside the earth (hereafter in this document, this power is referred to as intra-terrestrial electric power, not to be confused with the so-called standing waves) is very weak, so it is difficult to harness this electric power.

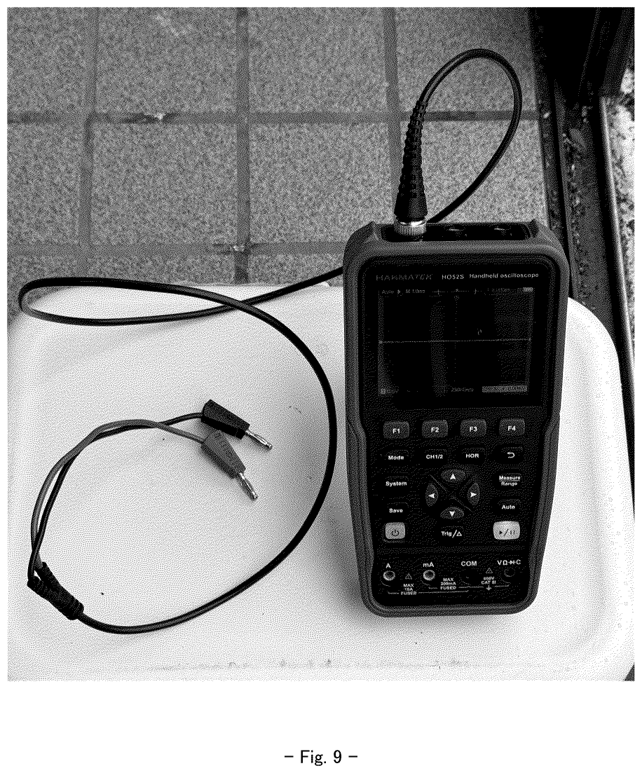

Therefore, the inventor measured intra-terrestrial electric power. FIG. 9 shows an external view of the oscilloscope used for the measurement. As shown in FIG. 9, when both tips of the two probes are placed in the atmosphere, no power is observed. Also, no power is observed when both tips of the two probes are buried underground.

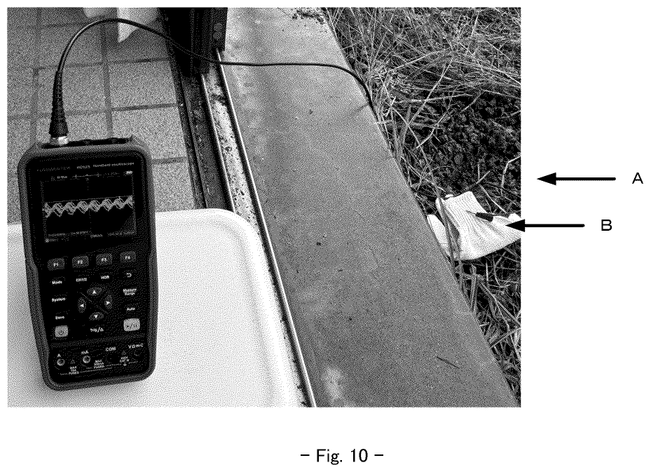

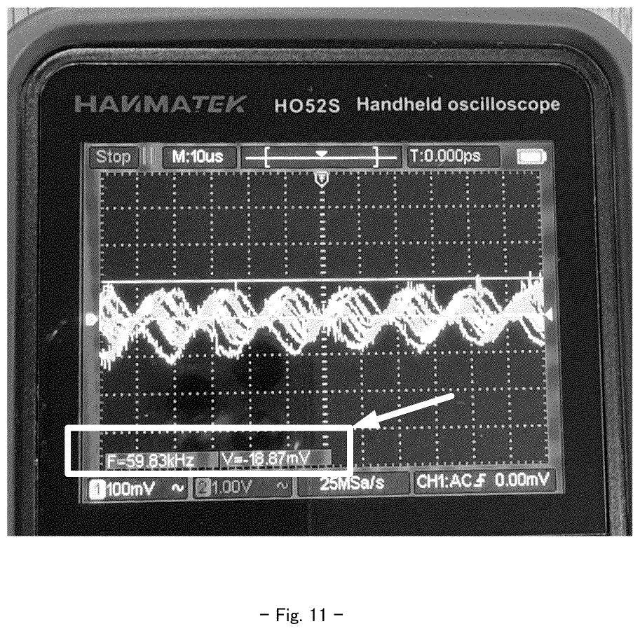

FIG. 10 is an external view of the oscilloscope during measurement. FIG. 11 is an enlarged view of the display of the oscilloscope in FIG. 10. As shown in FIG. 10, in the measurement, one of the two probes, the red probe (detection probe. The tip of the red probe (A. in FIG. 10) is buried in the ground, and the tip of the other probe (B. in FIG. 10), the black probe (grounding probe; see FIG. 10), is buried in the air. The tip of the other probe, the black probe (the grounding probe, FIG. 10 B.), was placed in the atmosphere. FIG. 11 (see the white box pointed to by the arrow). As shown in FIG. 11, the measured values were an average frequency (F) of 59.83 KHz and an average amplitude voltage (V) of −18.87 mV. It was also observed that there were multiple AC powers with different phases. Note that no power was observed when the tip of the black probe was buried underground, and the tip of the red probe was placed in the atmosphere. Therefore, it is possible to collect power from underground, i.e., from the earth's crust, and the power observed above is not power from radio waves or other sources in the atmosphere.

The oscilloscope used for the observations was a HANMATEK oscilloscope, part number HO52S. Measurements were taken with this oscilloscope in auto mode after waveform correction and with the average value calculation option turned on. The measurement date was Sep. 22, 2024, with a temperature of 19° C. and cloudy weather after rainfall. The measurement location was Miyamori-cho, Tono City, Iwate Prefecture. The above observations were made after autocalibration with both tips of the two probes placed in the atmosphere. Therefore, the average amplitude voltage above is the potential difference between the two probes and the potential of the two probes with both tips placed in the atmosphere.

### Power Feeding Device

FIG. 9 is a block diagram showing the configuration of the power feeder 81. As shown in FIG. 9, the power feeder 81 comprises a power collection unit 811, a superposition unit 812, a DC-AC conversion unit 813, and a voltage adjustment unit 814.

The power collection unit 811 comprises an AC-DC converter unit 811. The AC-DC converter unit 811 comprises a so-called rectifier device that converts AC current to DC current and may also comprises a smoothing circuit that smoothes the voltage waveform of the DC current. Examples of rectifier and smoothing circuit circuits can be a combination of known circuits published in books, websites, etc., as appropriate.

The AC-DC converter 8111 comprises one electrode, the first electrode 8112, and the other electrode, the second electrode 8113. The first electrode 8112 is formed by a conductor, and the tip where the conductor is exposed is placed in the ground or in the water of a body of water in contact with the earth's crust (hereinafter referred to as underwater together with underwater in lakes and rivers). The first electrode 8112 is used to collect intra-terrestrial electric power. The second electrode 8113 is formed by a conductor, and the tip of the conductor exposed is placed in the earth's atmosphere. The AC power input from the first electrode 8112 and the AC power of intra-terrestrial electric power to be collected is input to the AC-DC converter 8111.

One or more of the power collection units 811 can be received depending on the power demanded by the load 82. The number of power collection units 811 may be as few as one if the power demanded by the load 82 is relatively small or if the power collection efficiency of the power collection unit 811 is good. If there is only one power collection unit 811, the superimposed unit 812 may not be provided.

The power collection efficiency of the power collection unit 811 can be increased by forming the wiring of the power collection unit 811 and the AC-DC converter unit 811 and the wires used for each electrode using materials with extremely low electrical resistance, such as superconducting wires, for example, or by selecting geographical locations where particularly high power can be collected The following is an example of a typical example of a superconducting wire.

A plurality of power collection units 811 is provided when the power demanded by the load 82 is relatively large or when the power collection efficiency of the power collection unit 811 is not very good. When more than one power collection unit 811 is provided, a superimposed unit 812 is provided.

The superposition unit 812 connects the DC power output from multiple power collection units 811 in series to increase the current and voltage. The superposition unit 812 considers one power collection unit 811 as a DC power source and increases the current and voltage by connecting the positive or negative pole of this DC power source to the negative or positive pole of the other power collection unit 811.

The DC-AC converter unit 813 inputs the output from the superposition unit 812 when the superposition unit 812 is provided, or from the power collection unit 811 when the superposition unit is not provided. The DC-AC converter unit 813 comprises a so-called inverter that converts DC current to AC current. The DC-AC converter unit 813 can be a combination of known circuits published in books, websites, etc., as appropriate.

The voltage adjustment unit 814 is provided when the output voltage of the DC-AC converter unit 813 is different from the voltage required by the load 82. The specific configuration of the voltage adjustment unit 814 can be a combination of known circuits published in books, websites, etc., as appropriate. Commercially available transformers, especially transformers with stabilizers, can also be used.

The operation of the power feeder 81 will now be described. As shown in FIG. 11, the intra-terrestrial electric power collected from the first and second electrodes 8112 and 8113 is AC power, but there are multiple AC powers in this crustal power that have different phases. It is troublesome, if not impossible, to align the phases of these AC power. Therefore, the AC-DC converter 8111 of the power collection unit 811 converts the collected intra-terrestrial electric power to DC power once, where the phase is not an issue. Then, the DC power output by the power collection unit 811 is superimposed by series connecting each of the power collection unit 811 as a DC power source to boost the voltage and increase the current. Furthermore, this DC power is converted to AC power by the DC-AC converter 813, and then voltage is adjusted according to the load 82 by the voltage regulator 814 and supplied to the load 82.

For example, if the average frequency (F) is 59.83 KHz and the average amplitude voltage (V) is −18.87 mV, as observed above, about 2800 the power collection units 811 should be provided and connected in series. In this way, practical power can be obtained. Since the configuration of the power collection units 811 is simple, about 100 of them can be placed on a single circuit board. Then, 28 of these circuit boards are all that is needed.

Each of the first electrodes 8112 and the second electrodes 8113 can be put together by bundling or connecting them respectively. When configured in this manner, the power feeder 81 can be summarized to a weight and size that is portable enough for a human to carry.

As described above, this form of power feeder 81 comprises the power collection unit 811 comprises a first electrode 8112, which is formed by a conductor and whose exposed tip is placed in the earth or in water in a body of water in contact with the earth's crust, a second electrode 8113, which is formed by a conductor and whose exposed tip is placed in the earth's atmosphere, an AC-DC converter 8111 that converts the AC current input from the first electrode 8112 into a DC current, a superposition unit 812 that boosts the DC power output by the power collection unit 811 by series connection, a DC-AC converter 813 that converts the DC power output by the superposition unit 812 into AC power.

The power feeder 81 in this embodiment comprises the power collection unit 811 comprises a first electrode 8112 formed by a conductor and placed in water in the earth or in a body of water in contact with the earth's crust at the tip where the conductor is exposed, a second electrode 8113 formed by a conductor and placed in the earth's atmosphere at the tip where the conductor is exposed, an AC-DC converter 811 that converts the AC current input from the first electrode 8112 into DC current, a DC-AC converter 813 that converts the DC power output by the power collection unit 811 into AC power.

Thus, the invention has the effect of providing a power feeder 81 that harvests and supplies energy from the natural world.

### Unmanned Aerial Mobile Entity and Aerial Mothership

The unmanned aerial vehicle 91 (hereinafter referred to as “an aerial vehicle 91”) in accordance with an embodiment of the present invention is described in detail with reference to the drawings. will be described in detail with reference to the drawings.

### Basic Concept

Conventional aircraft have large wings, which require a large space for storage. In addition, models that could take off and land vertically generated lift and propulsive force mainly by propellers and fans. Therefore, some models were prone to accidents due to their slow travel speed and unstable posture. In addition, fighter aircraft not only required time-consuming and expensive training for pilots, but the abrupt changes in attitude could also be physically harmful to the pilots.

### Regarding the Main Wings

In this form of the aerial mobile 91, lifting power is not generated by the main wings, but comprises a power source for generating lift (hereinafter referred to as lift engine 921). Specifically, the aerial mobile 91 comprises a jet engine, which is a power source that draws the oxygen necessary to burn fuel from the atmosphere, or a rocket engine, which is a power source that loads the oxygen or oxidizer necessary to burn fuel into the aircraft and mixes this oxygen or oxidizer with the fuel to burn it.

Thus, the aerial mobile 91 does not have wings that generate lifting power greater than that generated by the lift engine 921. Therefore, the aerial mobile 91 saves space when stored.

The aerial mobile 91 comprises a power source that moves the aircraft forward and backward and generates power (hereinafter referred to as the propulsion engine 922) using the jet engine or rocket engine for the propulsion engine 922 and is provided separately from the lift engine.

Thus, not only can they take off and land vertically, but they can also take off rapidly and travel at high speeds, such as the speed of sound.

### About the Pilot

The airborne mobile 91 can be operated unmanned by the motion controller 940. The motion controller 940 stores in advance the operations of the lift and propulsion engines 922 required for the operation corresponding to the specified operation instructions and reads these operations to control the operation of the lift and propulsion engines 922, including the flaps 9211 for reverse thrusting.

Thus, there is no need for the pilot to be on board the aircraft, saving the time and expense associated with training the pilot.

Furthermore, since the aerial mobile 91 does not have a pilot on board, it is capable of rapid and complex posture changes, such as rapid somersaults, for example, which would not be feasible if a person were on board. Thus, the aerial mobile 91 can take extremely advantageous positions and postures against enemy fighters piloted by humans during so-called dogfights between fighters and can effectively eliminate enemy fighters.

### Regarding Componentization of Airframe Elements

The aerial mobile 91 comprises a componentized airframe element, which is a functional part mounted on a fuselage portion or the like, and a detachable component that can be easily replaced with a component of the airframe element.

Thus, the aerial mobile 91 can be changed by replacing this component to become, for example, a transport, a fighter, or a mobile with the necessary functions for the mission. And it is no longer necessary to load both transport and fighter aircraft on an aircraft carrier, for example, and further space savings can be achieved.

### Configuration Example

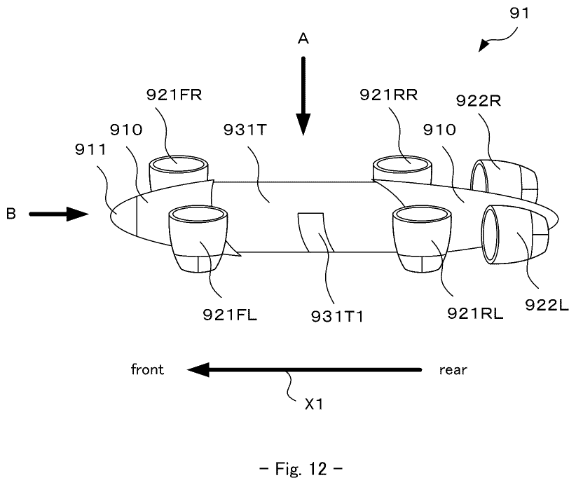

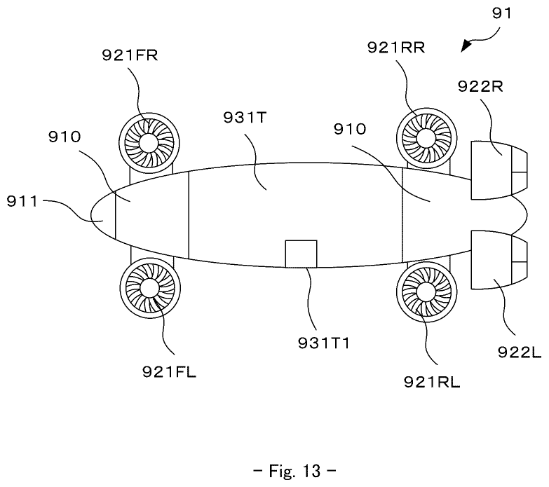

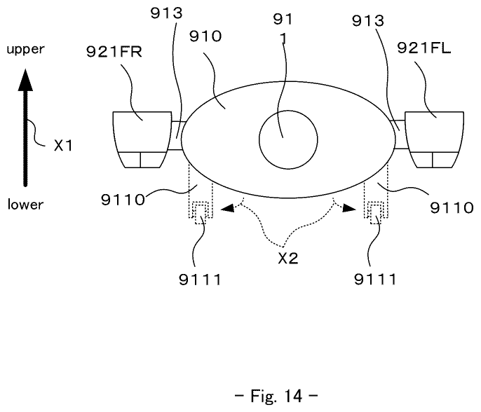

FIG. 12 is a side exterior view of the aerial mobile 91. FIG. 13 is an A-sagittal view in FIG. 12 of the aerial mobile 91. FIG. 14 is a B-sagittal view in FIG. 12 of the aerial mobile 91. As shown by arrow X1 in FIG. 12, the propulsion engine 922 (propulsion engine 922R and propulsion engine 922L are hereinafter collectively referred to as propulsion engine 922) are referred to as forward in the direction of the atmospheric inlet and backward in the direction of the exhaust gas outflow. The following is an example where jet engines are used for the lift engine 921 and propulsion engine 922 of the aerial mobile 91.

The aerial mobile 91 may comprises a power supply unit that supplies power received from the power feeder 81 (described below) to loads housed inside, and a separate secondary battery may be provided to store the received power. In this case, the aerial mobile 91 can receive power from the power feeder 81 installed on the ground and store the received power in the secondary battery installed inside the aerial mobile 91. Furthermore, the aerial mobile 91 may comprises the barrier generating device 71 described above. The barrier generating device 71 can receive a supply of stored electric power from the secondary battery described above. Similarly, the aerial mothership described below may have the barrier generating device 71 described above.

As shown in FIGS. 12 through 14, the aerial mobile 91 comprises a main body 910 and a transport component 931T, which is an example of component 931.

The main fuselage 910 comprises an equipment storage unit 911, a lift engine 921 (hereafter, the front right engine 921FR, front left engine 921FL, rear right engine 921RR, and rear left engine 921RL are collectively referred to as lift engine 921) and propulsion engine 922.

The equipment storage unit 911 stores the motion control unit 940 in the forward leading portion of the main fuselage 910.

The lift engines 921 are jet or rocket engines. The lift engines 921 include a front right engine 921FR installed on the forward right side of the main fuselage 910, a front left engine 921FL installed on the forward left side of the main fuselage 910, a rear right engine 921RR installed on the rear right side of the main fuselage 910, and a rear left engine 921RL.

The lift engine 921 is installed with the air inlet direction facing upward and the exhaust gas outflow direction facing downward. The lifting engine 921 is attached to the main fuselage 910 via mounting members 913 but may also be directly attached to the main fuselage 910.

Transport component 931T comprises hatch 931T1 for loading and unloading goods in the side portion of transport component 931T.

As shown in FIG. 14, the main body 910 comprises a support retirement 9110 with wheels 911, which can be retracted inside the main body 910. The support retirement 9110 is opened in the direction of arrow X2 when in use.

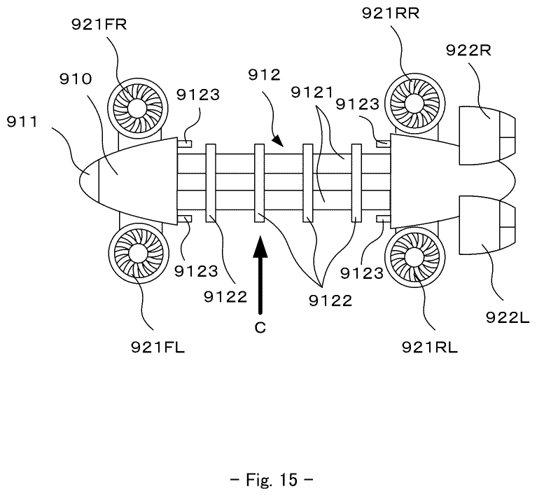

FIG. 15 is a plan view of the aerial mobile 91 with the component 931 removed. As shown in FIG. 15, the aerial mobile 91 has a pier 9121, a receiver 9122, and a lock 9123.

The pier 9121 connects and supports the front portion of the main body 910 equipped with equipment storage unit 911, the front right engine 921FR, and the front left engine 922FL, and the rear portion of main body 910 comprises the rear right engine 921RR, the rear left engine 921RL, and the propulsion engine 922.

The receiving portion 9122 is crossed over the top of the cleat 9121 by a plurality of cleats perpendicular to and intersecting the direction of extension of the cleat 9121.

A plurality of locks 9123 are disposed on the front portion of the main fuselage 910 and on the rear portion of the main fuselage 910 opposite the component 931 and are inserted into insertion holes pre-provided in the component 931, thereby securing the component 931 to the main fuselage 910.

The lock 9123 is protruded or retracted by the solenoid, protruding to the secure component 931 to the main body 910 when the solenoid is energized OFF and retracting to allow the component 931 to be removed from the main body 910 when the solenoid is ON.

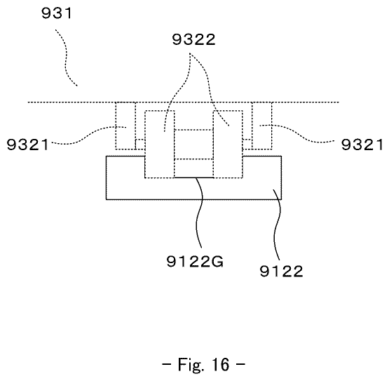

FIG. 16 is a C-sagittal end view in FIG. 15 of receiving unit 9122. The solid and dashed lines represent the receiving portion 9122 and the component 931, respectively. As shown in FIG. 16, the receiving portion 9122 has a receiving groove 9122G above.

The receiving groove 9122G has a width approximately equal to the width of the roller 9322 of the roller unit 9321 that the component 931 has on its lower surface. When the solenoid is energized, the component 931 is placed on the main body 910 by moving the rollers 9322 on the receiving groove 9122G. The solenoid is then turned off and the component 931 is secured to the main machine body.

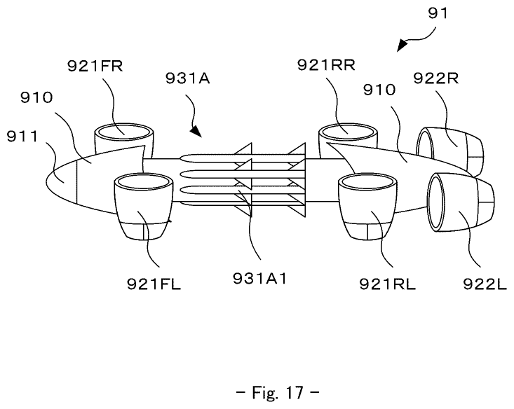

FIG. 17 is a diagram of a combat component 931A, another example of component 931. As shown in FIG. 17, the combat component 931A can selectively carry multiple missiles 931A1 as well as machine guns, bombs for dropping, or self-destructing bombs for dropping and detonating on enemy facilities.

In addition to these components, the component 931 can be newly established depending on the application, for example, a reconnaissance component with reconnaissance equipment, a camp component with facilities for encampment directly at the landing site, a medical component with facilities for performing medical treatment at the landing site, etc. The component 931 can also be selected. It is also possible to leave the component 931 at the selected location and return only the main aircraft 910.

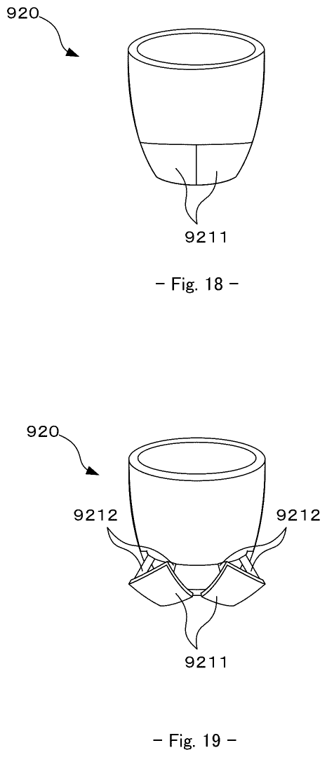

FIG. 18 shows an example of a jet engine 920 used for lift engine 921 and propulsion engine 922. FIG. 19 shows an example of the jet engine 920 with the flap 9211 for reverse thrust open. As shown in FIGS. 18 and 19, the jet engine 920 is equipped with the flap 9211 for reverse injection near the exhaust hole of the jet engine 920.

When the jet engine 920 is mechanically or electrically directed to backfire, it extends arm 9212 and the displaces flap 9211 to a position where it strikes the exhaust air exiting through the exhaust hole of the jet engine 920. At this time, the exhaust of the jet engine 920 is redirected by the flap 9211 in a direction approximately opposite to the direction in which the exhaust blows out. Thus, the output of the jet engine 920 acts in the opposite direction to the direction of travel.

An arm 9212 is extended by energizing the solenoid connected to the arm 9212, and when the solenoid is de-energized, it is housed within the housing of the jet engine 920.

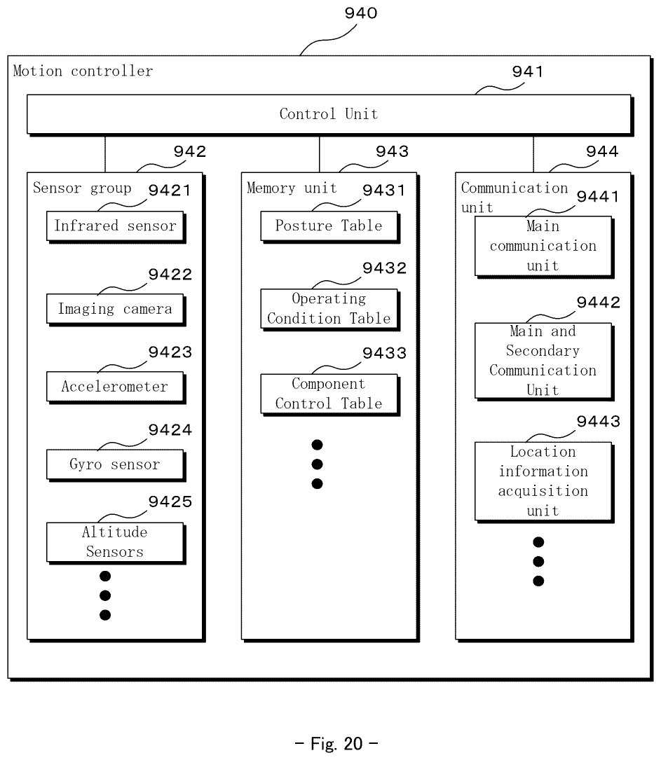

FIG. 20 is a block diagram of the motion controller 940. The motion controller 940 controls the motion of the aerial mobile 91. As shown in FIG. 20, the motion controller 940 has a control unit 941, a sensor group 942, a memory unit 943, and a communication unit 944.

The control unit 941 comprises a CPU (Central Processing Unit) or other computing devices.

The sensor group 942 includes, for example, an infrared sensor 9421, an imaging camera 9422 that captures visible light, an acceleration sensor 9423 that detects acceleration of the aerial mobile 91 in each three-dimensional direction, a gyro sensor 9424 that detects attitude displacement of the aerial mobile 91 in each three-dimensional direction, a laser beam or air pressure to a altitude sensor 9425 detects the altitude of the aerial mobile 91 from the ground surface by means of a laser beam or air pressure. Each sensor in the sensor group 942 outputs detection results to the control unit 941.

The storage unit 943 comprises a storage device selected from a variety of memory and storage devices. The storage unit 943 stores the posture table 9431, the operating condition table 9432, and the component control table 9433.

The communication unit 944 comprises a main communication unit 9441, a main-subordinate communication unit 9442, and a location information acquisition unit 9443. The main communication unit 9441 is equipped with a communication device for communication with the base, and the main-subordinate communication unit 9442 comprises a communication device for communication between the main unit, which gives instructions to other 91 aerial vehicles, and the subordinate unit, which is the 91 aerial vehicle that follows these instructions. The position information acquisition unit 9443 comprises a communication device for acquiring position information of the main aircraft from, for example, GPS (The Global Positioning System), and outputs the acquired position information to the control unit 941.

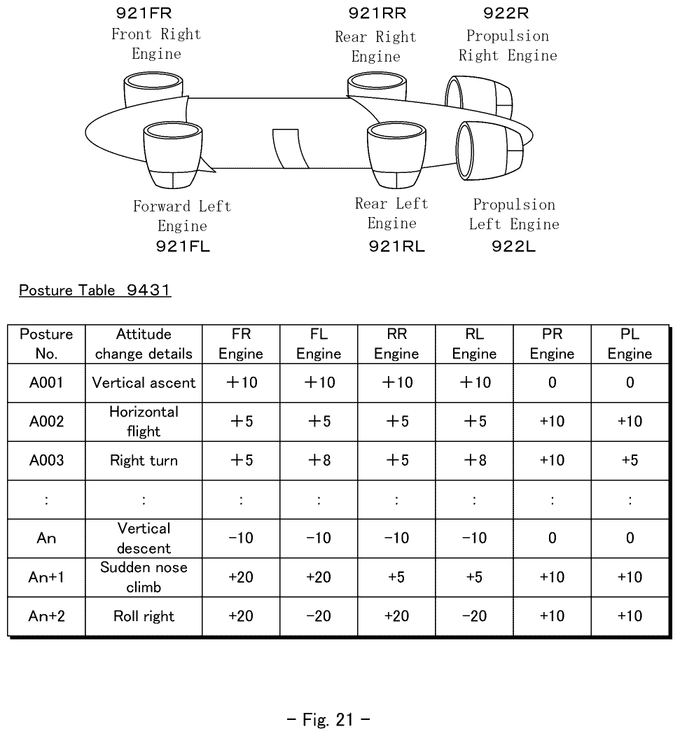

FIG. 21 shows an example of the data structure of attitude table 9431. Attitude table 9431 stores the output for each engine for each content of the change in attitude of the aerial mobile 91.

As shown in FIG. 21, the attitude table 9431 contains the attitude No., which is an identifier uniquely assigned to each attitude of the aerial mobile 91, the attitude change content indicating the content of the attitude change of the aerial mobile 91, and the output of each engine of the lift engine 921 and each engine of the propulsion engine 922 for each attitude change content The output of each engine of the lift engine 921 and each engine of the propulsion engine 922 for each attitude change is converted into numerical values and stored. Here, for example, +10 indicates 10% of the maximum output in the forward direction that does not activate the flaps 9211, and −20 indicates 20% of the maximum output in the reverse direction that causes the flaps 9211 to operate.

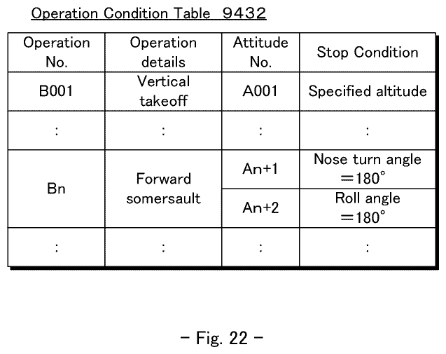

FIG. 22 shows an example of the data structure of the operation condition table 9432. The operation condition table 9432 stores the conditions for stopping the posture change of the aerial mobile 1 for each operation of the aerial mobile 91.

As shown in FIG. 22, the motion condition table 9432 stores the motion No., which is an identifier uniquely assigned to the content of each motion of the aerial mobile 91, the posture No., which corresponds to the posture used for each motion of the aerial mobile 91, and the motion stop condition, which indicates the condition for stopping the maintenance of the posture indicated by the posture No.

The operation of the control unit 941 in the case of changing the posture of the aerial mobile unit 1 will now be described. First, when the control unit 941 determines that it has received an instruction for an operation to change the posture of the aerial mobile 91, it searches the operation condition table 9432 to read the posture No. and the operation stop condition corresponding to the operation content of the specified operation.

For example, if the control unit 941 receives an instruction to start operation No. Bn (forward somersault), the control unit 941 searches operation condition table 9432 to read the posture No. corresponding to operation No. Bn and the condition for stopping the operation.

Next, the control unit 941 searches the posture table 9431 to read out the output of each engine corresponding to the posture No., and adjusts the output of each engine according to the readout. In the above example, the control unit 941 reads posture No.: “An+1”, operation stop condition: “model turning angle=180°”, and posture No.: “An+2”, operation stop condition: “roll angle=180°” respectively.

Next, the control unit 941 adjusts the output of each engine corresponding to attitude No. An+1 to implement the nose rapid ascent. Then, the control unit 941 determines whether the model turn angle has reached 180°, and if it determines that it has, it changes the output of each engine corresponding to attitude No. An+1 to the output of each engine corresponding to attitude No. An+2.

The control unit 941 then determines whether the roll angle has reached 180°, and if it has, the output of each engine is returned to default (e.g., constant speed advance.).

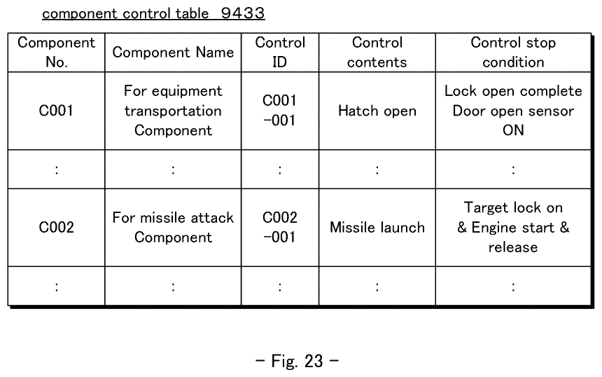

FIG. 23 shows an example of the data structure of component control table 9433. The component control table 9433 stores the contents of the operation for each component 931 and the conditions for stopping that operation.

As shown in FIG. 23, component control table 9433 stores a component No., which is an identifier uniquely assigned to each component 931, a component name, a control ID, which is an identifier uniquely assigned to the control contents, a control contents, and a control stop condition.

For example, when the aerial mobile 91 is equipped with an equipment transport component, if the control unit 941 determines that it has received a control ID: C001-001, which is an instruction to open the hatch, it performs a lock open and door open operation, which is a hatch opening operation stored beforehand, and if the control unit 941 determines that the control stop condition “lock open & door open sensor ON” is satisfied, the hatch opening operation is stopped.

### Other Examples of Aerial Mobiles

The aerial mobile 91 is space-saving. Therefore, it is possible to mount several of them on a large aircraft. For example, an aerial mobile 91 with combat component 931A is loaded onto a large aircraft, an airborne mother ship, and transported to the vicinity of the enemy base. Then, when an instruction is issued from the base to launch an attack, the aerial carrier releases the 91 aerial mobile unit and has the 91 aerial mobile unit launch the attack. This operation can reduce the fuel consumption of the aerial mobile 91, and if refueling equipment is installed on the aerial carrier, continuous attacks are possible.

### Effect

As described above, the unmanned aerial vehicle 91 in this embodiment comprises a plurality of lift engines, which are jet engines or rocket engines that generate lift, a plurality of propulsion engines, which are jet engines or rocket engines that generate propulsion, a group of sensors that detect posture, a memory unit that stores a plurality of operations to complete the posture change operation for each posture change operation, and a control unit that starts the plurality of operations read from the memory corresponding to the posture change operation by controlling the outputs of the lift engines and the propulsion engines when the control unit determines that an instruction to perform the posture change operation has been received, continues the posture change operation until the control unit determines that the posture change operation is completed because all of the plurality of operations have been completed based on the output of said sensor group, and does not comprise a main wing that generates a lifting power than the lifting power generated by the lift engine.

Thus, the aerial vehicle 91 has the effect of saving space.

### Transmission System

The following is a detailed description of a power transmission system 100 in accordance with one embodiment of the present invention, with reference to the drawings.

### Basic Concept

There are various conventional technologies for wireless power transmission systems, including magnetic field coupling systems and electric field coupling systems. All the wireless power transmission systems in practical use use a coil on the transmitting side and a coil on the receiving side, and alternating current is passed through them. Therefore, there was usually only one frequency of alternating current used.

When there is a distance between the transmitter and receiver devices, or when the power required by the load is large, the voltage of the AC current must be increased, and as a result, there was a limit to the power that could be transmitted.

Therefore, in the power transmission system 100, power is transmitted using alternating current of multiple frequencies. Furthermore, in the power transmission system 100, a radio lens is used, which is formed by a conductive medium with a different propagation velocity of radio waves from that of the atmosphere or outer space, and outputs transmitted waves from the medium at an angle of transmission different from the angle of incidence of the incident waves.

Transmitted radio waves, which are radio waves that carry the power to be transmitted, are output from a single antenna. The transmitted radio waves output from the antenna spread radially and are redirected by a convex radio lens toward the convex radio lens at the power receiver. The convex radio lens at the receiving end converges the transmitted radio waves and converts them into an AC voltage of the desired voltage.

Thus, according to the transmission system 100, it can transmit more power than conventional transmission techniques by at least several times the frequency used for transmission radio waves.

### Power Transmission System

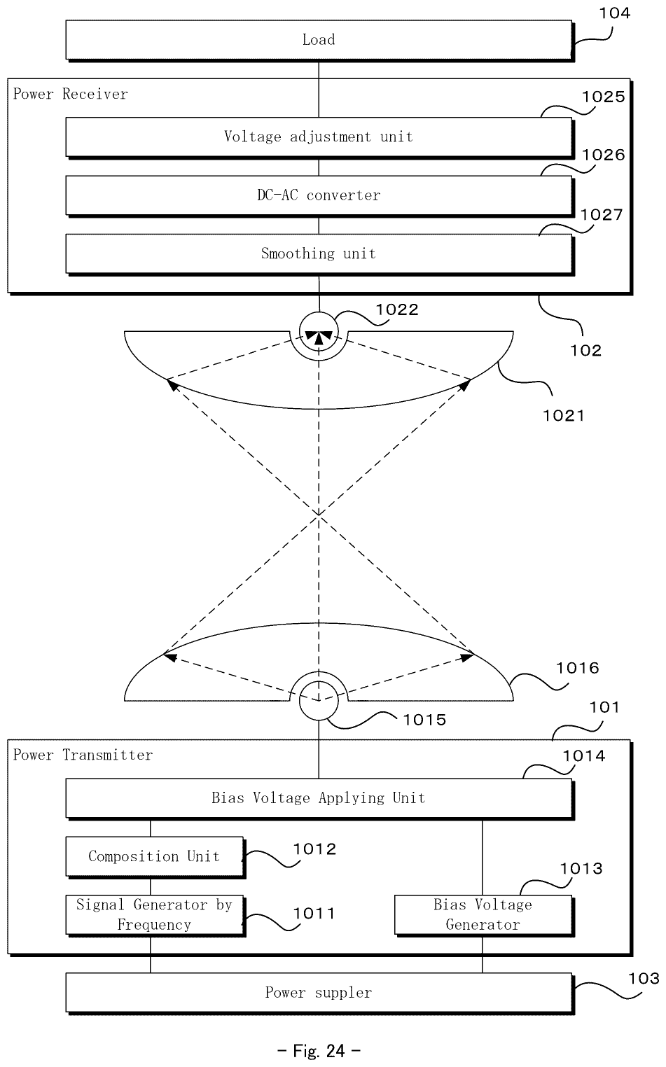

FIG. 24 is a block diagram of the first embodiment of a power transmission system 100. As shown in FIG. 24, the power transmission system 100 has a transmission unit 101, a transmission side radio lens 1016, a receiving the radio lens 1021, and a receiving unit 102.

### Power Transmission Unit

The power transmitting unit 101 comprises a frequency-specific signal generator 1011 that generates an AC signal of multiple frequencies for each frequency from the electric power supplied from the power supply unit 103, a synthesizing unit 1012 that synthesizes the AC signal of multiple frequencies generated by the frequency-specific signal generator 1011 into one signal, a bias voltage generator 1013 that generates a bias voltage from the electric power supplied from the power supply unit 103, a bias voltage applying unit 1014 applies the bias voltage generated by the bias voltage generating unit 1013 to the combined signal synthesized output by the synthesizing unit 1012, and an antenna 1015 transmits the combined signal applied the bias voltage by the bias voltage applying unit 1014.

The power supply 103 may be external power or the power feeder 81 described above.

The frequency-specific signal generator 1011 generates an AC signal for each of the multiple frequencies. The AC signal may be a sine wave or other waveform. A signal generator to generate the AC signal can be selected from known circuits as appropriate. The frequency to be generated can be selected from several KHz to thousands of THz as appropriate. In other words, the frequency can be selected from the frequency of so-called radio waves to the frequency of γ rays.

The synthesis unit 1012 combines the AC signals generated and output by the frequency-specific signal generator 1011 into a single signal and outputs it as a synthesized signal.

The bias voltage generator 1013 generates a bias voltage with a DC component. The bias voltage may be simply a DC current.

The bias voltage application unit 1014 superimposes and applies the bias voltage generated by the bias voltage generator unit 1013 to the composite signal output by the composite unit 1012.

The power transmitting antenna 1015 is formed by a conductor and transmits a composite signal to which a bias voltage is applied by the bias voltage application unit 1014. It is desirable for the power transmitting antenna 1015 to have a spherical tip in terms of ease of designing a radio lens, but other shapes are also acceptable.

The material used for the power transmission antenna 1015 can be selected from materials used for conventional antennas. For example, a spherical antenna with a tip made of copper can be used. In this case, there are no restrictions on the diameter of the sphere if it is large enough to withstand the voltage of the transmitted radio waves.

### Radio Wave Lens

A radio wave lens is formed by a conductive medium in which the propagation speed of radio waves is different from that of the atmosphere or outer space, and outputs the transmitted wave from the medium at an angle of transmission different from the angle of incidence of the incident wave. The material of the radio lens can be, for example, copper.

The shape of the radio wave lens is selected according to the distance to be transmitted and the frequency of the transmitted radio wave. The shape of the radio wave lens can be selected as appropriate, for example, the shape of a convex lens for optics. Thus, the transmitting radio wave lens 1016 and the receiving radio wave lens 1021 may have the same shape or different shapes from each other.

Here, chromatic aberration can be a problem in optical magnifiers. Depending on the frequency used, it may be desirable to reduce chromatic aberration in radio waves as well. In this case, as in the case of optical lenses, chromatic aberration of radio waves can be reduced by using a chromatic aberration radio lens. The shape of the chromatic aberration lens can be selected based on the shape of the chromatic aberration lens of the optical system.

If a material with a different propagation speed of radio waves is needed for a color-masked radio wave lens, a material with a different propagation speed of radio waves can be prepared and used by doping the conductor material with another conductor material. For example, by doping copper with a material with lower electrical resistance than copper, such as gold or platinum, a material with a faster propagation speed of radio waves than copper can be obtained, and by doping copper with a material with higher electrical resistance than copper, such as nickel or chromium, a material with a slower propagation speed than copper can be obtained. The relationship between the propagation speed and the incident and transmission angles is described in detail in the public literature (e.g., Chapter 4 of the revised edition of “Fundamentals of Radio Engineering,” by Hideaki Wakabayashi, Oct. 10, 2017, published by University Educational Publishing Co.

Like lenses in optical systems, radio wave lenses can be used in combination with convex and concave lenses. In cases where it is desired to transmit radio waves at precise locations, convex and concave radio lenses can be used in combination with color-masked radio lenses, as appropriate.

### Power Receiving Unit

The power receiving unit 102 has a smoothing unit 1023 that smoothes the transmitted radio waves propagated from the receiving antenna 1022 that receives the transmitted radio waves converged by the receiving radio lens 1021, a DC-AC converter 1024 that converts the transmitted radio waves smoothed by the smoothing unit 1023 to generate AC power, a DC-AC converter 102 4, and a voltage adjustment unit 1025 that adjusts the voltage of the AC power output from the DC-AC converter 102104 according to the load 104.

The smoothing unit 1023 can use any known smoothing circuit selected as appropriate. The smoothing unit 1023 smoothes each frequency of the transmitted radio wave.

The DC-AC converter unit 1024, for example, can use a known inverter circuit selected as appropriate. The frequency of the output AC power can be selected from the frequency required by the load.

The voltage regulator 1025 can use any known voltage regulator circuit that performs a step-up or step-down voltage adjustment.

### Transmission Radio Waves

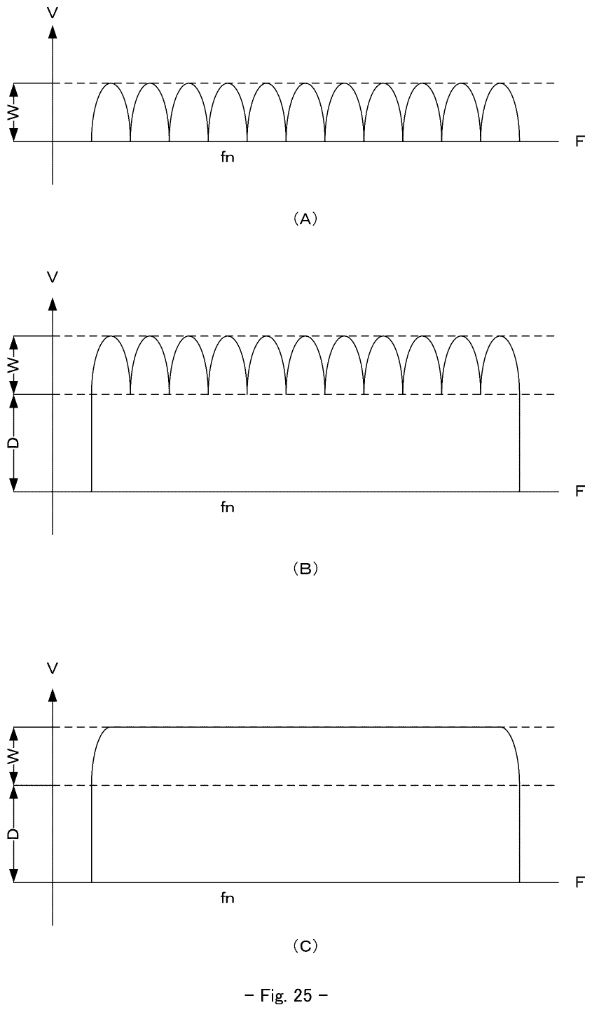

The following is an explanation of the transmission radio waves used in this system. FIG. 25 shows the changes in the transmitted radio waves.

FIG. 25(a) schematically shows the synthesized signal output by the synthesis unit 1012. In FIG. 25(A), the vertical axis indicates voltage (V) and the horizontal axis indicates frequency (F). As shown in FIG. 25(a), the synthetic signal is a synthesis of multiple frequencies. The amplitude of this synthesized signal is hereinafter referred to as waveform amplitude W. The synthesized signal is an AC signal.

FIG. 25(b) schematically shows the synthesized signal with bias voltage applied output by the bias voltage application unit 1014. In FIG. 25(b), the vertical axis indicates the voltage (V) and the horizontal axis indicates the frequency (F). As shown in FIG. 25(b), the synthetic signal to which the bias voltage is applied has a component of waveform amplitude W and a DC component D of the bias voltage. Therefore, since the composite signal to which the bias voltage is applied has a component of waveform amplitude W, it has the characteristics of a wave and can change the direction of propagation by the radio lens.

FIG. 25(c) schematically shows the transmitted radio wave smoothed by the smoothing unit 1023. In FIG. 25(c), the vertical axis indicates voltage (V) and the horizontal axis indicates frequency (F). As shown in FIG. 25(C), the smoothing unit 1023 smoothes each frequency of the transmitted radio wave, resulting in all frequencies being smoothed and the voltage becoming DC power, which is the waveform amplitude W and DC component D combined.

Thus, the DC-AC converter 1024 can be used to convert the transmitted radio waves to AC power of the desired frequency, which can then be adjusted to the desired voltage by the voltage regulator 1025.

### Variant

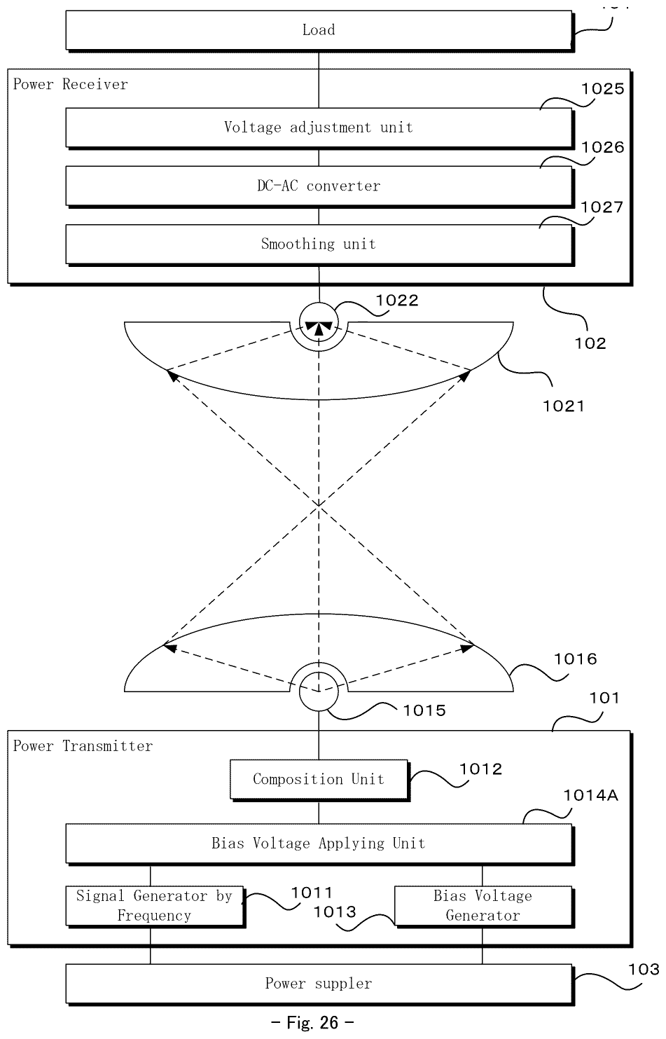

FIG. 26 is a block diagram showing a variant of the power transmission system 100 of the embodiment. The power transmission unit 101 of the embodiment shown in FIG. 24 combines the multiple frequency AC signals generated by the frequency-specific signal generator unit 1011 into a single signal by the synthesis unit 1012 before superimposing and applying the bias voltage generated by the bias voltage generator unit 1013. In contrast, as shown in FIG. 26, this variant differs in that the bias voltage generated by the bias voltage generator 1013 is superimposed and applied to the multiple frequency AC signals generated by the frequency-specific signal generator 1011 before the synthesis unit 1012 combines them into a single signal. The effect is almost the same as the power transmission unit 101 of the embodiment shown in FIG. 24.

### Effect

As described above, the power transmission system 100 in this embodiment comprises a transmission unit 101 that transmits AC power of multiple frequencies to which a bias voltage is applied as transmitted radio waves, a transmission side radio wave lens 1016 and a receiving side radio lens 1021 formed by a conductive medium with a different propagation velocity of radio waves from that of the atmosphere or outer space, and outputs the transmitted waves from the medium at an angle of transmission different from the angle of incidence of the incident waves, and a power receiver 102 that receives the transmitted radio waves transmitted through the transmitter side radio lens 1016 and converged by the receiver side radio lens 1021.

Thus, the invention has the effect of providing a wireless power transmission system that transmits power by radio.

### Power Transmission Equipment

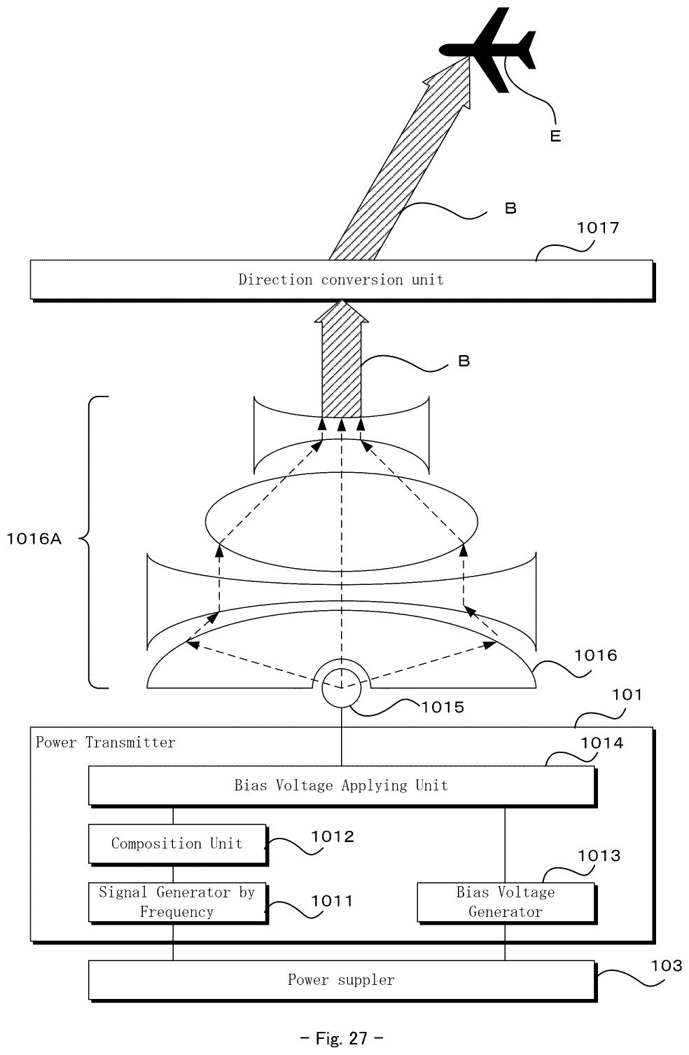

FIG. 27 shows a block diagram of a power transmission device that can be used in the power transmission system 100. As shown in FIG. 27, the power transmission device comprises the power transmission unit 101 described above, the transmission side radio lens group 1016A, and the direction conversion unit 1017.

The transmission side radio wave lens group 1016A comprises a plurality of radio wave lenses, including convex radio wave lenses, concave radio wave lenses, and, if necessary, color-masked radio wave lenses, to generate beam-like transmission radio waves B from the transmission radio waves output from the power transmission unit 101.

The direction conversion unit 1017 comprises a magnetic force generator that applies a magnetic force to the beam of transmitted radio waves B. The magnetic force changes the direction of propagation of the beam of transmitted radio waves B output from the transmission side radio lens group 1016A.

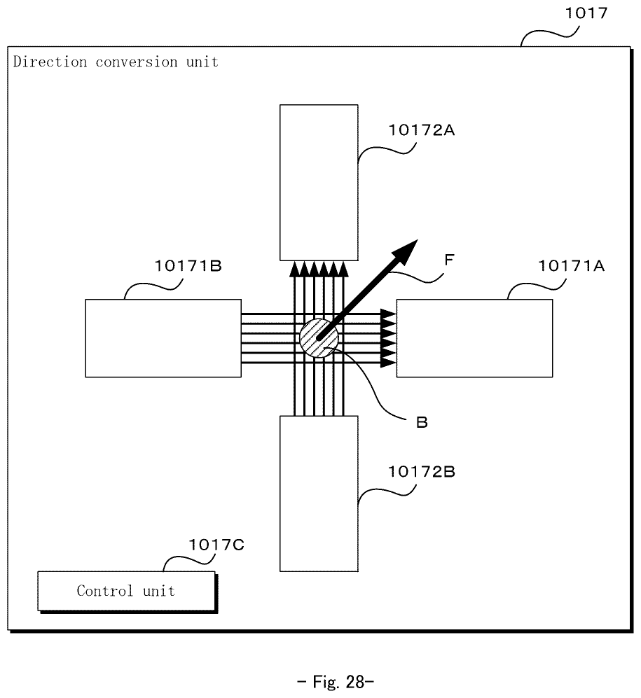

FIG. 28 is a block diagram of the direction conversion unit 1017. In FIG. 28, the direction conversion unit 1017 is illustrated as seen from the direction of propagation of the beam-shaped transmission radio wave B. As shown in FIG. 28, the direction conversion unit 1017 comprises a magnetic force generator that applies a magnetic force to the beam-shaped transmission radio wave B and a control unit 1017C, and changes the propagation direction of the beam-shaped transmission radio wave B output from the transmission side radio lens group 1016A by the magnetic force.

The magnetic force generator comprises, for example, a first coil pair (the first coil 10171A, which is one coil of the first coil pair, and the second coil 10171B, which is the other coil, together are referred to as the first coil pair) that are arranged so that their magnetic fluxes are orthogonal to each other and the second coil pair (the third coil 10172A, which is one coil of the second coil pair, and the fourth coil 10172B, which is the other coil, together referred to as the second coil pair). The magnetic force generator comprises a variable power supply that supplies power of current direction and voltage to each of the first coil pair and the second coil pair according to instructions from the control unit 1017C.

The multiple arrows illustrated from the first coil 10171A to the second coil 10171B indicate the magnetic flux and its direction. Power is supplied to the first coil 10171A and the second coil 10171B from the variable power supply under the direction of the control unit 1017C, and the first coil 10171A and the second coil 10171B produce a magnetic flux from the first coil 10171A to the second coil 10171B in the direction of the arrows illustrated in FIG. 28 The first coil 10171A and the second coil 10171B generate a magnetic flux from the first coil 10171A to the second coil 10171B in the direction of the arrow illustrated in FIG. 28.

The multiple arrows illustrated as going from the third coil 10172A to the fourth coil 10172B indicate the magnetic flux and its direction. Power is supplied to the third coil 10172A and the fourth coil 10172B from the variable power supply under the direction of the control unit 1017C, and the third coil 10172A and the fourth coil 10172B produce a magnetic flux from the third coil 10172A to the fourth coil 10172B in the direction of the arrows illustrated in FIG. 28 The third and fourth coils are supplied with power.

The control unit 1017C comprises an arithmetic unit such as a central processing unit (CPU), a memory or other storage device, and a communication device for communicating with external devices. When the control unit 1017C receives location information of a power transmission destination, such as an airborne moving object, the control unit 1017C calculates a direction to direct the beam-shaped power transmission radio wave B (e.g., a vertical direction as a reference axis and an angle between the reference axis and a direction to direct the beam-shaped power transmission radio wave B.) from the location information where the power transmission device has been installed and the received location information of the power transmission destination, and the control unit 1017C calculates the power applied to the first coil pair and the second coil pair required to change the direction of propagation of the beam of transmitted radio waves B in this direction.

The control unit 1017C then instructs the variable power supply unit to supply the calculated power to generate magnetic flux in the first coil pair and the second coil. In other words, the control unit 1017C adjusts the direction of the current and voltage applied to the first and second coil pairs to arbitrarily change the propagation direction of the beam-shaped transmitted radio wave B.

Therefore, according to Fleming's law, the direction of propagation of the beamy transmitted radio wave B is changed by the direction and force of the composite force F, which is the composite force of the force produced by the first coil pair and the force produced by the second coil pair.

### Effect

As described above, the power distribution system of this embodiment comprises a power transmitter 1017 that generates AC power of multiple frequencies to which a bias voltage is applied from the power supplied by the power supply 103 and transmits the power as transmitted radio waves, and a transmission unit 1017 that is formed by a conductive medium whose propagation speed of radio waves is different from that of atmosphere or outer space, and that has a plurality of radio lenses that output transmitted radio waves as transmitted waves from the medium by a transmission angle different from the angle of incidence of incident waves, a transmission side radio wave lens group 1016A comprising a plurality of radio wave lenses that output the transmitted radio wave as a transmitted wave from the medium at an angle of transmission different from the angle of incidence of the incident wave, and a direction conversion unit 1017 comprising a magnetic force generator that applies a magnetic force to the beam-shaped transmission radio wave B and uses the magnetic force to change the direction of propagation of the beam-shaped transmission radio wave B output from the transmission side radio lens group 1016A, changes the direction of propagation of the beam of transmitted radio waves B.

Thus, the invention has the effect, for example, of transmitting power to a moving object E moving in the air so that it can follow the moving object E as it continues to move in the air and its position changes.

### Description of Sign

1 Air defense system
11 Power supply unit
12 High-frequency signal generator
13 Gap switch
14 First junction
15 Phase control device
16 Second branch point
17 Synthesizer
18 Signal processor
19 Main control unit
20 Capacitor
30 Control unit by coil
31 Phase unit
31A Phase unit
32 Amplifier
33 Circulator
34 Limiter
40 Array Tesla Coil
41 Tesla coil
41A Primary coil
41B Secondary coil
41C Tertiary coil
41D Lead Delay
41E Sphere antenna
50 Cooling machine
51 Inlet hole
52 Pneumatic valve
A First connection point
B Second connection point
71 Shield barrier generator
72 Power supply unit
711 Frequency-specific electromagnetic wave generator
712 Phase control unit
713 Synthesizer
714 Amplifier
715 Antenna
7111 Electromagnetic wave generator
7112 Phase generator
81 Power feeder
82 Load
811 Power collection unit
8111 AC-DC converter
8112 First electrode
8113 Second electrode
812 Superposition unit
813 DC-AC converter
814 Voltage adjustment unit
91 Unmanned aerial vehicle
910 Main airframe
911 Equipment storage
913 Attachment
920 Jet engine
921 Lift engine
921FL Forward Left Engine
921FR Front Right Engine
921RL Rear Left Engine
921RR Rear Right Engine
922 Propulsion engines
922FL Front Left Engine
922L Propulsion Left Engine
922R Propulsion Right Engine
931 Components
931A Combat Components
931A1 Missile
931T Transport Component
931T1 Hatch
940 Motion controller
941 Control Unit
942 Sensor group
943 Memory unit
944 Communication unit
9110 Supporting bearing
9111 Wheel
9121 Cleats
9122 Receiving unit
9122G Receiving groove
9123 Lock
9211 Flap
9212 Arm
9321 Roller unit
9322 Roller
9421 Infrared sensor
9422 Imaging camera
9423 Accelerometer
9424 Gyro sensor
9425 Altitude Sensors
9431 Posture Table
9432 Operating Condition Table
9433 Component Control Table
9441 Main communication unit
9442 Main and Secondary Communication Unit
9443 Location information acquisition unit
100 Power Transmission System
101 Power Transmitter
102 Power Receiver
103 Power suppler
104 Load
1011 Signal Generator by Frequency
1012 Composition Unit
1013 Bias Voltage Generator
1014 Bias Voltage Applying Unit
1015 Transmission antenna
1016 Transmission side radio wave lens
1016A Transmission side radio wave lens group
1017 Direction conversion unit
1017C Control unit
10171A First coil
10171B Second coil
10172A Third coil
10172B 4th coil
1021 Radio wave lens on power receiving side
1022 Antenna on power receiving side
1023 Smoothing unit
1024 DC-AC converter
1025 Voltage adjustment unit
1026 DC-AC converter
1027 Smoothing unit

1. (canceled)

2. (canceled)

3. (canceled)

4. An unmanned aerial vehicle comprising:
a power supply unit that supplies AC power to be received from a power comprising:
a power collection unit including a first electrode formed by a conductor. an exposed tip of which is placed in the earth, or in water in a body of water in contact with the earth's crust, a second electrode formed by a conductor, an exposed tip of which is placed in the earth's atmosphere, and an AC-DC converter that converts AC current input from the first electrode to DC power:
a superposition unit that boosts the DC power output by the power collection unit by series connection; and
a DC-AC converter that converts the DC power outputted by the superposition unit into AC power;
a plurality of lift engines, which are jet engines or rocket engines that generate lift
a plurality of propulsion engines, which are jet engines or rocket engines that generate propulsion;
a group of sensors that detect posture;
a memory unit that stores a plurality of operations to complete the posture change operation for each posture change operation; and
a control unit that starts the plurality of operations read from the memory corresponding to the posture change operation by controlling the outputs of the lift engines and the propulsion engines when the control unit determines that an instruction to perform the posture change operation has been received, continues the posture change operation until the control unit determines that the posture change operation is completed because all of the plurality of operations have been completed based on the output of said sensor group,
wherein the unmanned aerial vehicle does not comprise a main wing that generates a lifting power more than the lifting power generated by the lift engines.

5. An unmanned aerial vehicle as claimed in claim 4, wherein
the unmanned aerial vehicle is equipped with combat equipment selected from one or more of the following: missiles, machine guns, bombs for dropping, and bombs for self-destruction.

6. A combat equipment according to claim 5, wherein the combat equipment is formed to be detachable from said unmanned aerial vehicle.

7. An airborne mother ship comprising:
a loading unit that loads the unmanned aerial vehicle of claim 4 therein;
a combat equipment selected from one or more of the following: missiles, machine guns, bombs for dropping, and bombs for self-destruction; and
a releasing unit that causes the aerial vehicle to be released from the loading unit at a transport destination and to initiate an attack based on an instruction to initiate the attack.

8. A power distribution system comprising:
a power supply unit that supplies AC power to be received from a power feeder comprising:
a power collection unit including a first electrode formed by a conductor, an exposed tip of which is placed in the earth, or in water in a body of water in contact with the earth's crust, a second electrode formed by a conductor, an exposed tip of which is placed in the earth's atmosphere, and an AC-DC converter that converts AC current input from the first electrode to DC power;
a superposition unit that boosts the DC power output by the power collection unit by series connection; and
a DC-AC converter that converts the DC power outputted by the superposition unit into AC power;
a power transmitter that generates alternating current of multiple frequencies to which bias voltage is applied from the power supplied by the power supply unit and transmits the power as transmitted radio waves;
a transmission side radio wave lenses and a receiving side radio wave lens formed by a conductive medium whose propagation velocity of radio waves is different from that of the atmosphere or outer space, and output the transmitted radio waves as transmitted waves from the medium at an angle of transmission different from the angle of incidence of the incident waves; and
a power receiving unit that receives the transmitted radio waves transmitted through the transmission side radio wave lens and converged by the receiving side radio wave lens.

9. (canceled)

10. (canceled)

11. A power transmitting device comprising:
a power supply unit that supplies AC power to be received from a power feeder comprising:
a power collection unit including a first electrode formed by a conductor. an exposed tip of which is placed in the earth, or in water in a body of water in contact with the earth's crust, a second electrode formed by a conductor, an exposed tip of which is placed in the earth's atmosphere, and an AC-DC converter that converts AC current input from the first electrode to DC power;
a superposition unit that boosts the DC power output by the power collection unit by series connection; and
a DC-AC converter that converts the DC power outputted by the superposition unit into AC power;
a power transmitter generates alternating current of multiple frequencies to which bias voltage is applied from the power supplied by the power supply unit and transmits the power as transmitted radio waves;
a transmission side radio wave lenses and a receiving side radio wave lens formed by a conductive medium whose propagation velocity of radio waves is different from that of the atmosphere or outer space, and output the transmitted radio waves as transmitted waves from the medium at an angle of transmission different from the angle of incidence of the incident waves; and
a magnetic force generator that applies a magnetic force to the beam of transmitted radio waves, and a direction converter that uses the magnetic force to change the direction of propagation of the beam of transmitted radio waves output from the transmission side radio lens.
